(19) United States
(12) Patent Application Publication
(10) Pub. No.: US 2026/0238919 A1
(43) Pub. Date: Aug. 13, 2026

(54) SPEAKER ASSEMBLIES AND EARPHONES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/645,278

(22) Filed: Apr. 12, 2026

Related U.S. Application Data
(63) Continuation of application No. PCT/CN2023/126026, filed on Oct. 23, 2023.

(51) Int. Cl. H04R 1/28; H04R 1/10; H04R 9/02; H04R 9/06

(52) U.S. Cl. CPC H04R 1/2888; H04R 1/105; H04R 1/1075; H04R 9/027; H04R 9/06; H04R 2460/11; H04R 2460/13

(57) ABSTRACT

A speaker assembly and an earphone are provided. The speaker assembly includes a housing assembly, an air conduction speaker, and a bone conduction speaker. The housing assembly is provided with an accommodation space. The air conduction speaker is disposed in the accommodation space. The bone conduction speaker is disposed in the accommodation space. The housing assembly further provided with a sound output hole and a pressure relief hole that are in communication with the accommodation space. The sound output hole and the pressure relief hole are respectively configured to conduct a portion of sound waves generated by the air conduction speaker to an external environment. The pressure relief hole and the sound output hole are respectively located on two opposite side surfaces of the housing assembly.

### CROSS-REFERENCE TO RELATED APPLICATIONS

This application is a continuation of International Patent Application No. PCT/CN2023/126026, filed on October 23, 2023, the contents of which are hereby incorporated by reference.

### TECHNICAL FIELD

The present disclosure relates to the field of electronic device technology, and in particular to a speaker assembly and an earphone.

### BACKGROUND

With the continuous popularization of electronic devices, the electronic devices have become indispensable social and entertainment tools in people’s daily life. People’s requirements for electronic devices are becoming increasingly higher. Electronic devices such as earphones and smart glasses have also been widely used in people’s daily life. The electronic devices may be used in conjunction with terminal devices such as mobile phones and computers to provide users with an excellent auditory experience.

In conventional earphones, sound waves are usually generated by driving the vibration of internal air and then transmitted to a user’s ear through a sound hole. However, the internal air in the earphone produces resistance against its vibration. For this reason, a pressure relief hole is usually provided in the earphones to release the pressure inside the earphones. Nevertheless, the sound output hole and the pressure relief hole are usually located relatively close to each other. The sound waves transmitted by the sound output hole and the sound waves transmitted by the pressure relief hole easily interfere with each other. Low-frequency sound waves transmitted by the sound output hole are easily weakened by a reverse-phase interference from the sound waves released during pressure relief at the pressure relief hole, which affects the sound quality of the earphone.

### SUMMARY

The present disclosure mainly solves a technical problem of providing a speaker assembly and an earphone. The speaker assembly and the earphone may reduce a mutual influence between a sound wave transmitted by a sound output hole and a sound wave transmitted by a pressure relief hole. The speaker assembly and the earphone may improve the low-frequency sound quality, thereby improving the sound quality.

To solve the above technical problem, a technical solution adopted by the present disclosure is to provide a speaker assembly. The speaker assembly includes a housing assembly, an air conduction speaker, and a bone conduction speaker. The housing assembly is disposed with an accommodation space. The air conduction speaker is disposed in the accommodation space. The bone conduction speaker is disposed in the accommodation space.

The housing assembly is further provided with a sound output hole and a pressure relief hole that are in communication with the accommodation space. The sound output hole and the pressure relief hole are respectively configured to conduct a portion of sound waves generated by the air conduction speaker to an external environment. The pressure relief hole and the sound output hole are respectively located on two opposite side surfaces of the housing assembly.

In some embodiments, the speaker assembly is provided with a pressure relief channel communicating with the pressure relief hole. The sound output hole communicates with the accommodation space, and the pressure relief channel is configured to guide a portion of the sound waves generated by the air conduction speaker in the accommodation space to the pressure relief hole.

In some embodiments, the pressure relief channel and the accommodation space are spaced apart from each other, and the pressure relief channel communicates with the accommodation space.

In some embodiments, the accommodation space includes a first accommodation cavity and a second accommodation cavity separated from each other, the bone conduction speaker is disposed in the first accommodation cavity, the air conduction speaker is disposed in the second accommodation cavity, the sound output hole communicates with the second accommodation cavity, the pressure relief channel is spaced apart from the first accommodation cavity, and the pressure relief channel communicates with the second accommodation cavity and the pressure relief hole.

In some embodiments, in a vertical direction perpendicular to an arrangement direction of the first accommodation cavity and the second accommodation cavity, the pressure relief channel and the first accommodation cavity are spaced apart.

In some embodiments, a length component of an extension length of the pressure relief channel along the arrangement direction is greater than a length component of the extension length along the vertical direction.

In some embodiments, the housing assembly is provided with a first partition wall between the first accommodation cavity and the second accommodation cavity, and a second partition wall between the pressure relief channel and the first accommodation cavity; the first partition wall separates the second accommodation cavity and the first accommodation cavity; and the second partition wall is configured to separate the pressure relief channel and the first accommodation cavity.

In some embodiments, the first partition wall further extends between the second accommodation cavity and the pressure relief channel, the first partition wall is provided with a sound guiding hole, and the sound guiding hole communicates with the second accommodation cavity and the pressure relief channel.

In some embodiments, the first accommodation cavity and the second accommodation cavity are separated from each other; and an area of a communication portion between the first accommodation cavity and the external environment is less than an area of a communication portion between the second accommodation cavity and the external environment, and an area of a communication portion between the pressure relief channel and the external environment.

In some embodiments, the housing assembly is provided with a first communication hole between the first accommodation cavity and the second accommodation cavity. The first communication hole communicates with the first accommodation cavity and the second accommodation cavity, and the bone conduction speaker blocks the first communication hole, so that the first accommodation cavity and the second accommodation cavity are separated from each other.

In some embodiments, the housing assembly is provided with a second communication hole between the first accommodation cavity and the pressure relief channel. The second communication hole communicates with the first accommodation cavity and the pressure relief channel, and the bone conduction speaker blocks the second communication hole, so that the first accommodation cavity and the pressure relief channel are separated from each other.

In some embodiments, the speaker assembly includes a channel tube forming the pressure relief channel. The channel tube is fixedly disposed in the housing assembly and located in the second accommodation cavity, one end of the channel tube communicates with the second accommodation cavity, and the other end of the channel tube communicates with the pressure relief hole.

In some embodiments, a portion of the accommodation space forms the pressure relief channel.

In some embodiments, the bone conduction speaker is configured as a sealed structure, and an interior of the bone conduction speaker is separated from the accommodation space. The pressure relief channel is defined by a space enclosed between the bone conduction speaker and an inner wall of the accommodation space.

In some embodiments, the accommodation space includes a first accommodation cavity and a second accommodation cavity spaced apart from each other. The bone conduction speaker is disposed in the first accommodation cavity. The pressure relief channel is defined by a space enclosed between the bone conduction speaker and the inner wall of the first accommodation cavity. The air conduction speaker is disposed in the second accommodation cavity. The housing assembly is provided with a sound guiding hole between the first accommodation cavity and the second accommodation cavity, and the sound guiding hole communicates with the first accommodation cavity and the second accommodation cavity.

In some embodiments, the bone conduction speaker includes a cylindrical cover, a driving assembly, and two sealing plates. The cylindrical cover is fixedly connected to the housing assembly, the driving assembly is disposed in the cylindrical cover, and the driving assembly is configured to drive the cylindrical cover to vibrate, thereby driving the housing assembly to vibrate. The two sealing plates are respectively disposed at two ends of the cylindrical cover and block the cylindrical cover to form the sealed structure.

In some embodiments, the bone conduction speaker includes a vibration transmitting plate. The driving assembly includes a voice coil assembly and a magnet assembly, the voice coil assembly is sleeved on the magnet assembly, the vibration transmitting plate fixedly connects the cylindrical cover to one of the voice coil assembly and the magnet assembly, and the other one of the voice coil assembly and the magnet assembly is fixedly connected to the cylindrical cover.

In some embodiments, the bone conduction speaker has a first central axis and is capable of generating vibration along a direction of the first central axis. The air conduction speaker has a second central axis and is capable of generating vibration along a direction of the second central axis. The housing assembly includes a first housing, a second housing, and a third housing. The first housing, the second housing, and the third housing together enclose to form the accommodation space. The second housing is connected to the first housing along the direction of the first central axis, and the third housing is connected to the second housing along the direction of the second central axis. The sound output hole is provided in the third housing, and the pressure relief hole is provided in a portion of the first housing opposite to the third housing.

In some embodiments, the first housing is provided with a pressure relief channel, one end of the pressure relief channel communicates with the accommodation space, and the other end of the pressure relief channel forms the pressure relief hole.

In some embodiments, the accommodation space includes a first accommodation cavity and a second accommodation cavity spaced apart from each other, the bone conduction speaker is disposed in the first accommodation cavity, and the air conduction speaker is disposed in the second accommodation cavity. The sound output hole communicates with the second accommodation cavity, and the pressure relief channel communicates with the second accommodation cavity. The second housing and the first housing cooperate to form the first accommodation cavity, and the third housing and the first housing cooperate to form the second accommodation cavity.

To solve the above technical problem, another technical solution adopted by the present disclosure is to provide an earphone. The earphone includes a wearing assembly and the speaker assembly as described above. The wearing assembly is connected to the speaker assembly.

Beneficial effects of the present disclosure are as follows. Different from the related art, the present disclosure disposes the pressure relief hole and the sound output hole on two opposite sides of the housing assembly of the speaker assembly. Therefore, a distance between the sound output hole and the pressure relief hole is increased. Consequently, the mutual influence between the sound wave transmitted by the sound output hole and the sound wave transmitted by the pressure relief hole can be reduced. The destructive interference between the sound output hole and the pressure relief hole in a near-field is reduced, which can weaken the sound waves transmitted from the sound output hole. Therefore, a sound cancellation phenomenon between the sound output hole and the pressure relief hole is weakened. A low-frequency sound quality can be improved, thereby improving the sound quality.

### BRIEF DESCRIPTION OF THE DRAWINGS

FIG. 1 is a schematic diagram illustrating a finally assembled three-dimensional (3D) structure of an earphone according to an embodiment of the present disclosure;

FIG. 2 is a schematic diagram illustrating a partial 3D structure of an ear hook of a speaker assembly according to an embodiment of the present disclosure;

FIG. 3A is a schematic diagram illustrating an exploded structure of a speaker assembly according to an embodiment shown in FIG. 2;

FIG. 3B is a schematic diagram illustrating an exploded structure of another embodiment of the speaker assembly shown in FIG. 2;

FIG. 4 is a schematic diagram illustrating the speaker assembly along a cross-section line A-A according to the embodiment shown in FIG. 2;

FIG. 5A is another schematic diagram illustrating the speaker assembly along a cross-section line A-A according to the embodiment shown in FIG. 2;

FIG. 5B is another schematic diagram illustrating the speaker assembly along a cross-section line A-A according to the embodiment shown in FIG. 2;

FIG. 6 is another schematic diagram illustrating a 3D structure of the speaker assembly according to the embodiment shown in FIG. 2;

FIG. 7 is a schematic diagram illustrating a positional relationship between a first central axis and a second central axis in the speaker assembly according to the embodiment shown in FIG. 2;

FIG. 8 is a schematic diagram illustrating an exploded structure of a bone conduction speaker according to an embodiment shown in FIG. 3A;

FIG. 9 is a schematic diagram illustrating the bone conduction speaker along a cross-section line B-B according to the embodiment shown in FIG. 8;

FIG. 10 is a schematic diagram illustrating a 3D structure of an air conduction speaker according to an embodiment shown in FIG. 3A;

FIG. 11 is a schematic diagram illustrating an exploded structure of the air conduction speaker according to the embodiment shown in FIG. 10;

FIG. 12 is a schematic diagram illustrating an exploded structure of another speaker assembly according to the embodiment shown in FIG. 2;

FIG. 13 is a schematic diagram illustrating an implementation of the speaker assembly along a cross-section line A-A according to the embodiment shown in FIG. 12;

FIG. 14 is a schematic diagram illustrating another implementation of the speaker assembly along a cross-section line A-A according to the embodiment shown in FIG. 12;

FIG. 15 is a schematic diagram illustrating another implementation of the speaker assembly along a cross-section line A-A according to the embodiment shown in FIG. 12;

FIG. 16 is a schematic diagram illustrating a structure of a vibration transmitting plate in the bone conduction speaker according to the embodiment shown in FIG. 8;

FIG. 17 is a schematic diagram illustrating an exploded structure of a speaker assembly according to another embodiment of the present disclosure;

FIG. 18 is a schematic diagram illustrating an implementation of the speaker assembly along a cross-section line C-C according to the embodiment shown in FIG. 17;

FIG. 19 is a schematic diagram illustrating another implementation of the speaker assembly along a cross-section line C-C according to the embodiment shown in FIG. 17;

FIG. 20 is a schematic diagram illustrating another implementation of the speaker assembly along a cross-section line C-C according to the embodiment shown in FIG. 17; and

FIG. 21 is a schematic diagram illustrating another implementation of the speaker assembly along a cross-section line C-C according to the embodiment shown in FIG. 17.

### DETAILED DESCRIPTION

The present disclosure is described in further detail below with reference to the accompanying drawings and embodiments. It is specifically pointed out that the following embodiments are merely for illustrating the present disclosure, and do not limit the scope of the present disclosure. Similarly, the following embodiments are only some embodiments of the present disclosure, not all embodiments. All other embodiments obtained by those skilled in the art based on the embodiments of the present disclosure, without creative efforts, shall fall within the protection scope of the present disclosure.

Reference to “an embodiment” in the present disclosure means that a particular feature, structure, or characteristic described in connection with the embodiment may be included in at least one embodiment of the present disclosure. Those skilled in the art explicitly and implicitly understand that the embodiments described in the present disclosure may be combined with other embodiments.

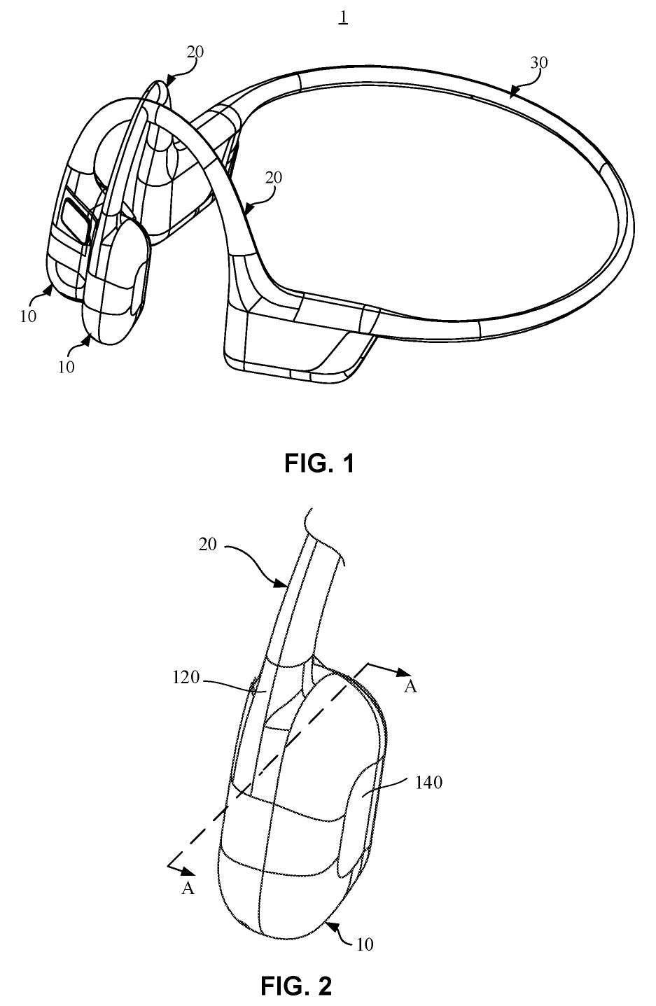

As shown in FIG. 1, an earphone 1 may include a speaker assembly 10, an ear hook 20, and a rear hanger 30.

The speaker assembly 10 may include a speaker and a corresponding core module, including an assembly housing, circuit components, etc. There may be two speaker assemblies 10. The two speaker assemblies 10 are respectively configured to transmit vibration and/or sound to the left ear and the right ear of a user. The two speaker assemblies 10 may be the same or different. For example, one speaker assembly 10 is provided with a microphone, while the other speaker assembly 10 is not provided with a microphone. Certainly, both of the two speaker assemblies 10 may be provided with the microphones. As another example, one speaker assembly 10 is provided with a button and a corresponding circuit board, and the other speaker assembly 10 is not provided with a button and a corresponding circuit board. Speakers included in the two speaker assemblies 10 are the same or different. The speaker assembly 10 described subsequently in the present disclosure may be considered as a detailed description, taking one of the two speaker assemblies 10 as an example.

There may be two ear hooks 20. The two ear hooks 20 may be respectively hooked on the left ear and the right ear of the user, so that the speaker assembly 10 can fit a face of the user. For example, one ear hook 20 is provided with a battery, and the other ear hook 20 is provided with a control circuit, etc. One end of the ear hook 20 is connected to the speaker assembly 10, and the other end of the ear hook 20 is connected to the rear hanger 30. The ear hook 20 may also be referred to as a wearing assembly 20.

The rear hanger 30 may connect the two ear hooks 20. The rear hanger 30 may be configured to go around a rear side of a neck or a rear side of a head of the user, and may provide a clamping force, so that the two speaker assemblies 10 are clamped on two sides of the face of the user, and the ear hooks 20 are more stably hooked on ears of the user. Certainly, the earphone 1 may also not include the rear hanger 30, and the speaker assembly 10 is worn on the ear of the user through the ear hook 20.

In some embodiments, the earphone 1 does not include the rear hanger 30, and the speaker assembly 10 is worn on the ear of the user through the ear hook 20. Alternatively, in some embodiments, the earphone 1 does not include the ear hook 20. The speaker assembly 10 is connected by a head-worn structure or a neck-worn structure, and the speaker assembly 10 is pressed against the face of the user or stably disposed outside the ear of the user through the head-worn structure or the neck-worn structure.

The following content mainly exemplarily describes structures such as the speaker assembly 10 of the earphone 1.

As shown in FIGS. 2-4, the speaker assembly 10 includes a housing assembly 100, a bone conduction speaker 200, and an air conduction speaker 300. The housing assembly 100 may be provided with an accommodation space 110. The air conduction speaker 300 may be disposed in the accommodation space 110, and the bone conduction speaker 200 may be disposed in the accommodation space 110.

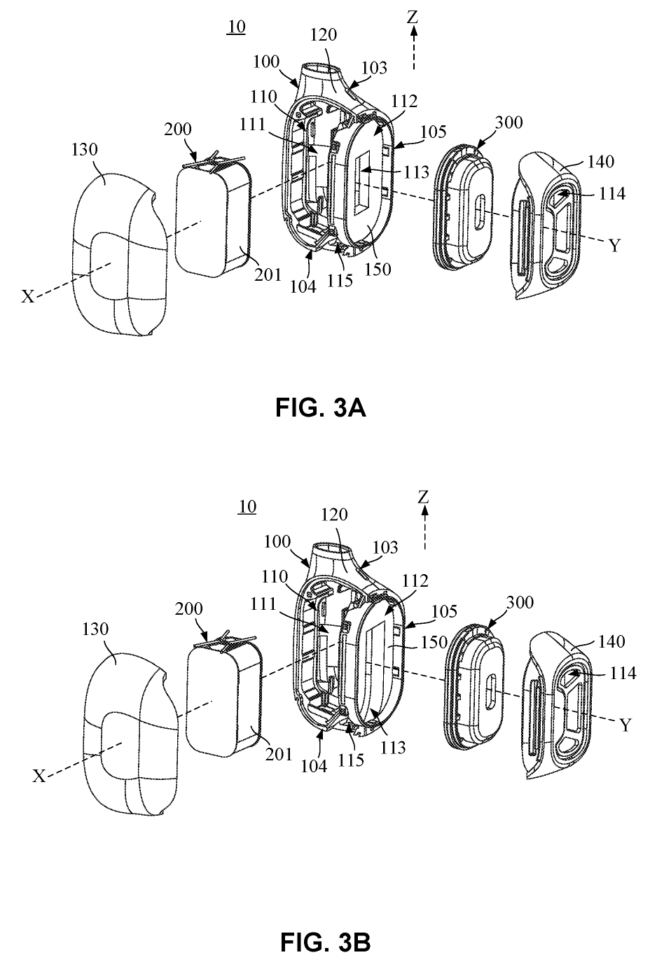

The accommodation space 110 is formed in the housing assembly 100, and the accommodation space 110 accommodates the air conduction speaker 300 and the bone conduction speaker 200. The accommodation space 110 may be an overall great space, or may be divided into two or more small spaces that are connected or disconnected. For example, in the embodiment shown in FIG. 3A, the housing assembly 100 is provided with a first accommodation cavity 111 and a second accommodation cavity 112. The first accommodation cavity 111 and the second accommodation cavity 112 are two connected or disconnected spaces.

In some embodiments, as shown in FIG. 3A, the housing assembly 100 is further provided with a communication hole 113 that communicates the first accommodation cavity 111 and the second accommodation cavity 112. In this way, at least the first accommodation cavity 111, the second accommodation cavity 112, and the communication hole 113 may together form the accommodation space 110. The bone conduction speaker 200 may be disposed in the first accommodation cavity 111 and block the communication hole 113, so that the first accommodation cavity 111 and the second accommodation cavity 112 are separated from each other. The air conduction speaker 300 may be disposed in the second accommodation cavity 112. In other embodiments, the communication hole 113 is not provided between the first accommodation cavity 111 and the second accommodation cavity 112, and the housing assembly 100 itself separates the first accommodation cavity 111 and the second accommodation cavity 112 from each other, so that the first accommodation cavity 111 and the second accommodation cavity 112 are not connected.

The air conduction speaker 300 is configured to conduct sound into an ear canal of the user through an air vibration principle, and the bone conduction speaker 200 is configured to conduct sound to the user through a bone conduction vibration manner. The second accommodation cavity 112, where the air conduction speaker 300 is located, needs to be connected to an external environment to facilitate the conduction of sound waves through air, and the bone conduction speaker 200 requires an environment with a strong impermeability to ensure a bone conduction effect. Therefore, by separately disposing the bone conduction speaker 200 and the air conduction speaker 300 in two different cavities in the accommodation space 110, a mutual interference between the bone conduction speaker 200 and the air conduction speaker 300 is effectively reduced, thereby effectively improving the sound quality of the earphone 1. The impermeability may be understood as an air tightness of a cavity space.

On the basis of the foregoing, by providing the communication hole 113 between the first accommodation cavity 111 and the second accommodation cavity 112, and using the bone conduction speaker 200 to block the communication hole 113 on one side of the communication hole 113, a use space of the first accommodation cavity 111 is expanded while ensuring a strong impermeability of the second accommodation cavity 112. In this way, an assembly convenience of the air conduction speaker 300 and a reliability of structural arrangement are effectively improved, and a volume of an acoustic cavity space formed by the air conduction speaker 300 in the second accommodation cavity 112 is simply and effectively expanded, and a sound output effect of the air conduction speaker 300 and a sound quality of the air conduction speaker 300 are improved. From another perspective, when the volume of the acoustic cavity space is kept unchanged, the air conduction speaker 300 may be disposed close to a side of the bone conduction speaker 200, which reduces the size of the speaker assembly 10 and achieves a compactness of an overall size.

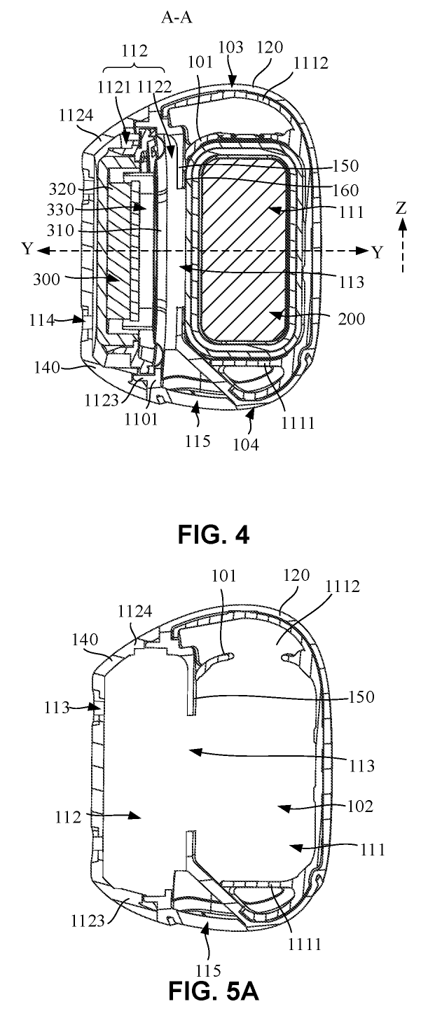

In some embodiments, as shown in FIG. 3A and FIG. 4, the housing assembly 100 may be provided with a sound output hole 114 and a pressure relief hole 115 that communicate the second accommodation cavity 112 and an external environment. The sound output hole 114 and the pressure relief hole 115 may be disposed at intervals.

The air conduction speaker 300 is disposed in the second accommodation cavity 112. The acoustic cavity space (an external acoustic cavity) of the air conduction speaker 300 may be formed in the second accommodation cavity 112.

By providing the communication hole 113 between the first accommodation cavity 111 and the second accommodation cavity 112, the second accommodation cavity 112 is allowed to communicate with the communication hole 113, and the bone conduction speaker 200 blocks the communication hole 113 on a side of the communication hole 113 opposite to the second accommodation cavity 112. Therefore, the acoustic cavity space in the second accommodation cavity 112 may be extended into the communication hole 113, so that the volume of the acoustic cavity may be increased, and a better acoustic effect may be provided. The sound output hole 114 may be used to guide the sound waves generated by the air conduction speaker 300 out of the speaker assembly 10 to propagate into an ear canal of the user. By providing the pressure relief hole 115 to communicate the second accommodation cavity 112 and the external environment, air is allowed to flow freely in the second accommodation cavity 112 and the air conduction speaker 300, thereby preventing the air in the second accommodation cavity 112 from generating damping on the vibration of the air conduction speaker 300, thereby affecting the sound quality of the air conduction speaker 300. Therefore, providing the pressure relief hole 115 may allow the earphone 1 to have a better sound quality effect.

Disposing the sound output hole 114 and the pressure relief hole 115 at intervals may reduce a mutual interference between the sound output hole 114 and the pressure relief hole 115, so that an air pressure discharged from the pressure relief hole 115 is less likely to affect the sound waves transmitted in the sound output hole 114, thereby improving the sound quality effect of the earphone 1.

In some embodiments, as shown in FIG. 3A and FIG. 4, the pressure relief hole 115 is in communication with the second accommodation cavity 112, the communication hole 113 is in communication with the second accommodation cavity 112, and the pressure relief hole 115 communicates with the communication hole 113 through the second accommodation cavity 112.

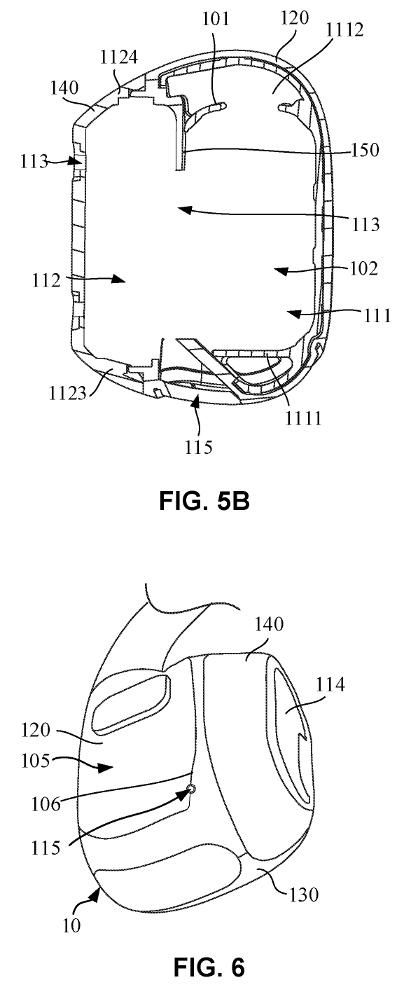

In another embodiment, as shown in FIG. 3B and FIG. 5B, the communication hole 113 directly communicates with the pressure relief hole 115. The bone conduction speaker 200 also blocks the communication hole 113 on a side of the communication hole 113 facing the first accommodation cavity 111, thereby ensuring the impermeability of the first accommodation cavity 111. At the same time, an area of an air inlet of the pressure relief hole 115 is increased, and the pressure relief effect of the pressure relief hole 115 is improved, thereby improving the sound quality effect of the speaker assembly 10.

In some embodiments, as shown in FIG. 3A and FIG. 4, the air conduction speaker 300 is configured to divide the second accommodation cavity 112 into a first sub-cavity 1121 and a second sub-cavity 1122 that are separated from each other. The first sub-cavity 1121 and the second sub-cavity 1122 are not in communication with each other. The sound output hole 114 may be in communication with the first sub-cavity 1121, and the pressure relief hole 115 may be in communication with the second sub-cavity 1122. Further, the communication hole 113 may be in communication with the second sub-cavity 1122.

Optionally, as shown in FIG. 3A, the air conduction speaker 300 includes a diaphragm 310 and a driving mechanism 320, and the driving mechanism 320 is connected to the diaphragm 310. An internal acoustic cavity 330 may be enclosed between the diaphragm 310 and the driving mechanism 320. A side of the diaphragm 310 opposite to the internal acoustic cavity 330 is an acoustic cavity space, which is also the second sub-cavity 1122. The driving mechanism 320 is configured to be controlled by an electrical signal to drive the diaphragm 310 to vibrate, thereby causing the air in the internal acoustic cavity 330 in the air conduction speaker 300 to vibrate to generate air conduction sound waves. The air conduction sound waves may be transmitted out of the speaker assembly 10 through the first sub-cavity 1121, the second sub-cavity 1122 (i.e., the acoustic cavity space), and the sound output hole 114.

In this case, the presence of the communication hole 113 may increase the volume of the second sub-cavity 1122, i.e., increase the volume of the acoustic cavity space, thereby enhancing the sound quality effect of the speaker assembly 10.

Specifically, during an operation of the earphone 1, a portion of the sound waves generated by the air conduction speaker 300 using the air vibration principle may be transmitted out of the speaker assembly 10 through the first sub-cavity 1121 and the sound output hole 114. The second sub-cavity 1122 may be in communication with the external environment via the pressure relief hole 115, so as to allow the air to flow freely between the external environment and the second sub-cavity 1122. If the second sub-cavity 1122 is sealed, during the operation of the air conduction speaker 300, the air in the second sub-cavity 1122 generates an air damping against the vibration of the air conduction speaker 300, thereby affecting the sound quality of the air conduction speaker 300. Thus, the pressure relief hole 115 may maintain an air pressure balance between the second sub-cavity 1122 and the external environment, thereby reducing an impact on a sound generated by the air conduction speaker 300, and further reducing an impact on the sound quality effect of the earphone 1.

In some embodiments, there is one or more pressure relief holes 115, and the plurality of pressure relief holes 115 are arranged at intervals. The plurality of pressure relief holes 115 may enhance a pressure relief effect, enabling the earphone 1 to have a better sound quality effect. Optionally, positions where at least two pressure relief holes 115 are in communication with the external environment on the housing assembly 100 may be located on different sides of the housing assembly 100, thereby reducing the probability of interference enhancement among the pressure relief holes 115.

In some embodiments, as shown in FIG. 3A, FIG. 4, and FIG. 5A, the housing assembly 100 includes a first housing 120, a second housing 130, and a third housing 140. The second housing 130 and the first housing 120 cooperate to form the first accommodation cavity 111 (schematically labeled on the first housing 120 in FIG. 4, but this does not mean the first accommodation cavity 111 is only the portion shown on the first housing 120). The third housing 140 and the first housing 120 cooperate to form the second accommodation cavity 112 (schematically labeled on the first housing 120 in FIG. 4, but this does not mean the second accommodation cavity 112 is only the portion shown on the first housing 120). The communication hole 113 may be formed in the first housing 120. The third housing 140 may be provided with the sound output hole 114 that communicates the second accommodation cavity 112 with the external environment. The first housing 120 may be provided with the pressure relief hole 115 that communicates the second accommodation cavity 112 with the external environment. Optionally, the pressure relief hole 115 may be disposed on a side of the first housing 120 opposite to the third housing 140, thereby making a distance between the pressure relief hole 115 and the sound output hole 114 relatively great.

By setting the first housing 120, the second housing 130, and the third housing 140 to abut and cooperate with each other to form the first accommodation cavity 111 and the second accommodation cavity 112, it may facilitate the assembly and disassembly of the speaker assembly 10, and also improve the structural compactness and the stability of the speaker assembly 10. Disposing the sound output hole 114 on the third housing 140 and disposing the pressure relief hole 115 on the first housing 120 makes the distance between the sound output hole 114 and the pressure relief hole 115 relatively great. The relatively great distance may reduce a mutual interference between the sound waves transmitted respectively through the sound output hole 114 and the pressure relief hole 115, and may reduce a probability of the sound waves transmitted from the sound output hole 114 and the pressure relief hole 115 undergoing a destructive interference in a near-field, thereby enabling the earphone 1 to have a better sound quality effect.

As shown in FIG. 2, the earphone may include the wearing assembly 20 and the speaker assembly 10 as described above. The wearing assembly 20 may also be referred to as the ear hook 20. Specifically, the wearing assembly 20 may be connected to the first housing 120. Connecting the wearing assembly 20 to the first housing 120 may make a connection between the wearing assembly 20 and the speaker assembly 10 relatively tight, thereby making the wearing assembly 20 less likely to detach from the speaker assembly 10 during use. Optionally, positions of the first housing 120 and the wearing assembly 20 correspond to the first accommodation cavity 111. Specifically, when the wearing assembly 20 is assembled on the first housing 120, the wearing assembly 20 may point toward the first accommodation cavity 111, causing the first housing 120 to be closer to the first accommodation cavity 111 than a swing position of the wearing assembly 20. Thus, when the bone conduction speaker 200 generates a vibration on the first housing 120, the first housing 120 may swing with a relatively great amplitude and a relatively fast swing speed, which improves the bone conduction sound quality.

In some embodiments, as shown in FIG. 3A to FIG. 4, the housing assembly 100 includes a partition wall 150 for separating the first accommodation cavity 111 and the second accommodation cavity 112. The communication hole 113 may be formed in the partition wall 150. The bone conduction speaker 200 may block the communication hole 113 on a side of the partition wall 150 facing the first accommodation cavity 111.

By using the partition wall 150 to separate the first accommodation cavity 111 and the second accommodation cavity 112, and further separating the bone conduction speaker 200 and the air conduction speaker 300, an air vibration generated when the bone conduction speaker 200 in the first accommodation cavity 111 vibrates is prevented from affecting and partially canceling the air conduction sound waves of the air conduction speaker 300. The partition wall 150 may thus prevent the bone conduction speaker 200 from affecting the transmission of the air conduction sound waves, and may also prevent the bone conduction speaker 200 and the air conduction speaker 300 from abutting and colliding with each other, thereby preventing mutual damage. As the partition wall 150 separates the first accommodation cavity 111 and the second accommodation cavity 112, assembly conveniences of the bone conduction speaker 200 and the air conduction speaker 300 may also be improved. Further, the bone conduction speaker 200 blocks the communication hole 113 on the side of the partition wall 150 facing the first accommodation cavity 111, thereby causing the communication hole 113 to be in communication with the second accommodation cavity 112. As a result, a space with a greater volume is formed, thereby improving the air conduction sound quality of the air conduction speaker 300.

In some embodiments, as shown in FIG. 4, the bone conduction speaker 200 may abut against the partition wall 150 to block the communication hole 113. In other words, a wall surface of the bone conduction speaker 200 directly or indirectly abuts against the partition wall 150 to block the communication hole 113, thereby ensuring the impermeability of the first accommodation cavity 111.

In other embodiments, a sealing member 160 is disposed between the bone conduction speaker 200 and the partition wall 150, and the sealing member 160 is disposed surrounding the communication hole 113. A side of the sealing member 160 may be pressed against the partition wall 150 and surround the communication hole 113, and an opposite side of the sealing member 160 may be pressed against a wall surface of the bone conduction speaker 200, thereby enabling the bone conduction speaker 200 to block the communication hole 113. Disposing the sealing member 160 between the bone conduction speaker 200 and the partition wall 150 may make the impermeability of the first accommodation cavity 111 stronger, thereby increasing the bone conduction effect.

In some embodiments, the sealing member 160 may include at least one of a sealant and a sealing ring. If the sealing member 160 is a sealant, the sealant may be applied by dispensing onto the partition wall 150 around the communication hole 113, and then the bone conduction speaker 200 may be pressed against the sealant and the partition wall 150 to block the communication hole 113. The sealing ring also has a good sealing performance. Therefore, disposing the sealing ring between the partition wall 150 and the bone conduction speaker 200 may also improve the sealing of the first accommodation cavity 111. Certainly, in other embodiments, the sealing member 160 may also be other components, such as a sealing gasket, soft packing, etc., which are not specifically listed one by one in this embodiment.

In some embodiments, as shown in FIG. 3A, FIG. 4, and FIG. 5A, the housing assembly 100 includes a support wall 101 disposed in the first accommodation cavity 111. The support wall 101 and the partition wall 150 together enclose a limiting space 102. The bone conduction speaker 200 is disposed in the limiting space 102 and abuts against the support wall 101. The support wall 101 and the partition wall 150 are configured to cooperate to limit the movement of the bone conduction speaker 200 relative to the housing assembly 100 in a radial direction.

Specifically, a direction in which the bone conduction speaker 200 vibrates relative to the housing assembly 100 may be an axial direction of the bone conduction speaker 200. A direction perpendicular to the axial direction of the bone conduction speaker 200 is a radial direction of the bone conduction speaker 200. The support wall 101 and the partition wall 150 may be configured to cooperate to limit the movement of the bone conduction speaker 200 relative to the housing assembly 100 in any radial direction perpendicular to the axial direction of the bone conduction speaker 200. The axial direction of the bone conduction speaker 200 may be two extension directions of an X line in FIG. 3A. The radial direction of the bone conduction speaker 200 may be two extension directions of a Y line in FIG. 3A and FIG. 4, but the radial direction is not limited to the specific direction shown by Y.

Optionally, one end of the support wall 101 may be connected to the first housing 120 or the second housing 130, and another end of the support wall 101 may extend toward the bone conduction speaker 200. The support wall 101 may correspond to and be adapted to an outer surface of the bone conduction speaker 200, so that the support wall 101 fits against the bone conduction speaker 200 in the radial direction of the bone conduction speaker 200. The support wall 101 and the partition wall 150 may be configured to cooperate to limit the movement of the bone conduction speaker 200 relative to the housing assembly 100 in the radial direction, thereby limiting the movement of the bone conduction speaker 200 to the axial direction of the bone conduction speaker 200, and also making an internal structure of the speaker assembly 10 more compact.

In some embodiments, as shown in FIG. 3A, the bone conduction speaker 200 has a first central axis X, and is configured to generate vibration in a direction of the first central axis X. The bone conduction speaker 200 may have a circumferential side surface 201 disposed around the first central axis X, and the circumferential side surface 201 blocks the communication hole 113. The two directions indicated by the first central axis X may also be the axial direction of the bone conduction speaker 200. The bone conduction speaker 200 generates vibration in the direction of the first central axis X and conducts the sound to a user in a bone conduction vibration manner.

Optionally, the circumferential side surface 201 of the bone conduction speaker 200 may abut against the support wall 101. The support wall 101 and the partition wall 150 may cooperate to act on the circumferential side surface 201 of the bone conduction speaker 200 to limit the movement of the bone conduction speaker 200 relative to the housing assembly 100 in the radial direction.

In some embodiments, as shown in FIG. 3A and FIG. 4, the air conduction speaker 300 has a second central axis Y. The air conduction speaker 300 is configured to generate vibration along the direction of the second central axis Y.

Optionally, the first central axis X and the second central axis Y may be perpendicular to each other. In this case, the direction of the first central axis X may be an axial direction of the bone conduction speaker 200. The direction of the second central axis Y may be a radial direction perpendicular to the axial direction of the bone conduction speaker 200.

Optionally, as shown in FIG. 3A, FIG. 4, and FIG. 6, the housing assembly 100 may have a first side 103, a second side 104, and a third side 105. The first side 103 and the second side 104 are disposed opposite to each other along a vertical direction Z of the first central axis X and the second central axis Y. The third side 105 is disposed adjacent to the first side 103 and the second side 104. Optionally, the first central axis X or the second central axis Y may pass through the third side 105. One of the pressure relief holes 115 may be provided on the first side 103 or the second side 104. Another one of the pressure relief holes 115 may be provided on the third side 105.

For example, in some embodiments, the first central axis X passes through the third side 105. The housing assembly 100 has a face-contacting side for transmitting the bone conduction vibration to the user’s face. The third side 105 is disposed opposite to the face-contacting side. In some other embodiments, the second central axis Y passes through the third side 105. The third side 105 and a side of the housing assembly 100 where the sound output hole 114 is located are disposed opposite to each other.

Providing a plurality of pressure relief holes 115 may increase a pressure relief area for pressure relief from the second accommodation cavity 112 to the external environment. Providing the plurality of pressure relief holes 115 may allow the air to flow quickly between the external environment and the second accommodation cavity 112. Providing the plurality of pressure relief holes 115 may further quickly discharge the air from the acoustic cavity in the second accommodation cavity 112 to the external environment. Providing the plurality of pressure relief holes 115 may reduce damping on the operation of the air conduction speaker 300 due to difficulty in air flow. Providing the plurality of pressure relief holes 115 may also avoid an impact on vibration sound waves of the air conduction speaker 300 caused by an inability to relieve the pressure in the second accommodation cavity 112 after one pressure relief hole 115 is blocked.

In some embodiments, different pressure relief holes 115 are disposed on different sides of the housing assembly 100. For example, the pressure relief hole 115 is disposed on the first side 103 or the second side 104 at a position corresponding to the second sub-cavity 1122, and another pressure relief hole 115 is disposed on the third side 105 at a position corresponding to the second sub-cavity 1122. This facilitates the connection of the pressure relief holes 115 to the second sub-cavity 1122. Moreover, such an arrangement may reduce the probability of interference, especially constructive interference, between sounds discharged from the pressure relief holes 115 while increasing the pressure relief area. Such an arrangement may improve sound quality and reduce the impact on the sound transmitted from the sound output hole 114.

In some embodiments, as shown in FIG. 6, the housing assembly 100 has a protruding body ridge line 106 on the third side 105. One pressure relief hole 115 penetrates the body ridge line 106 to be in communication with the external environment. When the earphone 1 is worn for use, an opening direction of the sound output hole 114 generally faces the user’s ear canal. A surface of the bone conduction speaker 200 corresponding to bone conduction generally contacts the skin near the ear canal. Therefore, the opening direction of the sound output hole 114 and the surface for bone conduction intersect to form an acute angle. The housing assembly 100 forms the protruding body ridge line 106 on the surface away from the user’s skin.

Optionally, the body ridge line 106 may be located on the first housing 120 at a position corresponding to the second accommodation cavity 112. This facilitates the communication of the pressure relief hole 115 on the body ridge line 106 to the second accommodation cavity 112. Disposing another pressure relief hole 115 at the body ridge line 106 may prevent the pressure relief hole 115 from being easily covered when the earphone 1 is worn for use. This ensures the air flow through the pressure relief hole 115. Certainly, in other embodiments, the body ridge line 106 on the third side 105 may also be recessed inward toward the interior of the housing assembly 100.

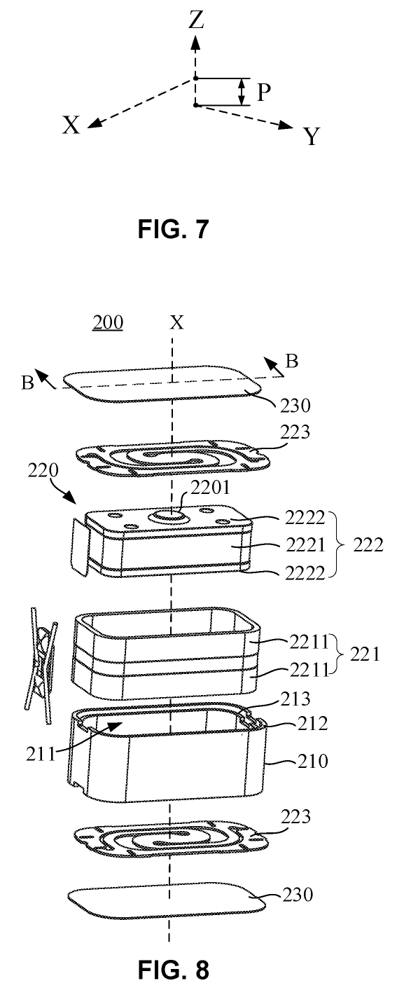

In some embodiments, as shown in FIG. 4, FIG. 5A, and FIG. 7, along the vertical direction Z perpendicular to the first central axis X and the second central axis Y, the first accommodation cavity 111 has a first bottom wall 1111 and a second bottom wall 1112 disposed opposite to each other. The second accommodation cavity 112 has a third bottom wall 1123 and a fourth bottom wall 1124 disposed opposite to each other. The first bottom wall 1111 and the third bottom wall 1123 may be disposed adjacent to each other. The second bottom wall 1112 and the fourth bottom wall 1124 may be disposed adjacent to each other. The vertical direction Z has a positive direction from the first bottom wall 1111 toward the second bottom wall 1112 and a negative direction opposite to the positive direction. The positive direction is shown by arrow Z in FIG. 3A and FIG. 7.

Optionally, the circumferential side surface 201 of the bone conduction speaker 200 may abut against the first bottom wall 1111. The first bottom wall 1111, the support wall 101, and the partition wall 150 together enclose a limiting space 102. The bone conduction speaker 200 may be disposed in the limiting space 102 and abut against the support wall 101 and the first bottom wall 1111.

In the positive direction, the lowest position of the first bottom wall 1111 may be higher than the lowest position of the third bottom wall 1123.

In some embodiments, as shown in FIG. 4, the housing assembly 100 has a wall portion 1101 adjacent to the first accommodation cavity 111 in the vertical direction. The pressure relief hole 115 is provided in the wall portion 1101.

Specifically, providing the pressure relief hole 115 in the wall portion 1101 between the first bottom wall 1111 and the third bottom wall 1123 may fully utilize the space inside the housing assembly 100. This improves the space utilization of the speaker assembly 10. Setting the lowest position of the first bottom wall 1111 higher than the lowest position of the third bottom wall 1123 allows the first bottom wall 1111 and the third bottom wall 1123 to be staggered in height along the positive direction of the vertical direction Z. The wall portion 1101 between the first bottom wall 1111 and the third bottom wall 1123 may have a relatively large space for disposing the pressure relief hole 115. Consequently, the size of the pressure relief hole 115 may be made relatively large. This may increase the size of the pressure relief hole 115 and enhance the pressure relief effect.

In some embodiments, as shown in FIG. 4 to FIG. 5A, the pressure relief hole 115 extends from the second accommodation space 110 outward through the wall portion 1101 in a flared shape. A portion of a hole wall of the pressure relief hole 115 near the third bottom wall 1123 gradually inclines toward a side where the third bottom wall 1123 is located in the negative direction. Such an arrangement further increases the size of the pressure relief hole 115, facilitating pressure relief through the hole and enhancing the acoustic performance of the speaker assembly 10.

In some embodiments, as shown in FIG. 3A and FIG. 7, the first central axis X and the second central axis Y are non-coplanar lines. Along the vertical direction Z perpendicular to the first central axis X and the second central axis Y, the first central axis X and the second central axis Y are staggered from each other.

The bone conduction speaker 200 vibrates along the direction of the first central axis X. The air conduction speaker 300 vibrates along the direction of the second central axis Y. Therefore, setting the first central axis X and the second central axis Y as non-coplanar lines and staggered from each other may reduce the mutual interference between vibrations of the bone conduction speaker 200 and the air conduction speaker 300. In this way, the sound generation and transmission effects of the bone conduction speaker 200 and the air conduction speaker 300 are enhanced.

For example, in some embodiments, as shown in FIG. 7, the first central axis X is set higher than the second central axis Y in the positive direction. This facilitates setting the lowest position of the first bottom wall 1111 higher than the lowest position of the third bottom wall 1123, thereby facilitating forming the flared pressure relief hole 115, and allowing a relatively large size of the flared pressure relief hole 115.

In some embodiments, as shown in FIG. 7, a distance P between the first central axis X and the second central axis Y is in a range of 0.2 mm-0.8 mm. The distance between the first central axis X and the second central axis Y is shown as distance P in FIG. 5A. For example, the distance P between the first central axis X and the second central axis Y is 0.3 mm, 0.5 mm, or 0.7 mm.

Optionally, the first central axis X is higher than the second central axis Y in the positive direction. Setting the distance between the first central axis X and the second central axis Y in this manner may control and reduce the size of the speaker assembly 10 while allowing the lowest position of the first bottom wall 1111 to be higher than the lowest position of the third bottom wall 1123.

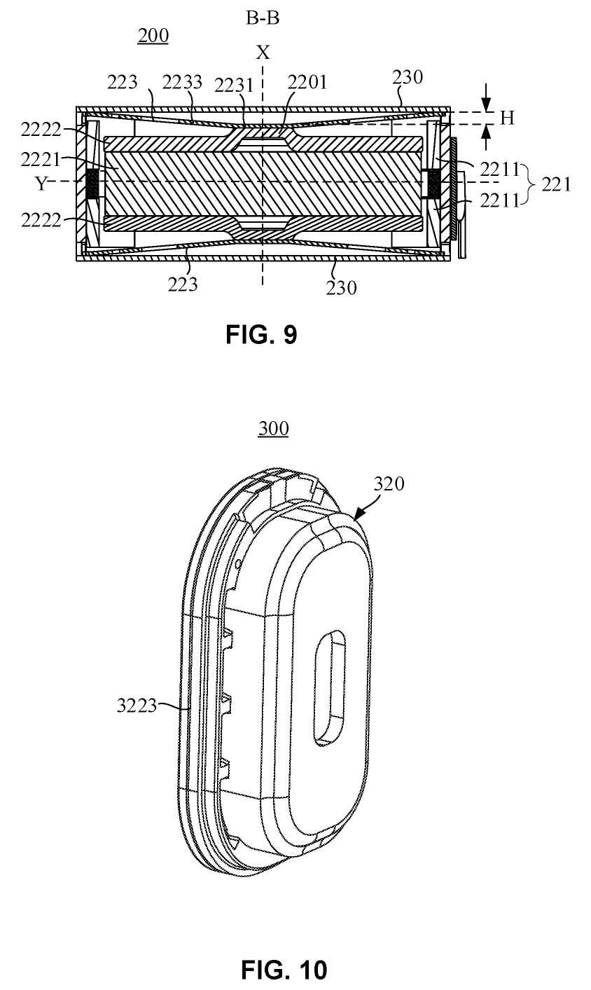

In some embodiments, as shown in FIG. 8 and FIG. 9, the bone conduction speaker 200 includes a cylindrical cover 210, a voice coil assembly 221, a magnet assembly 222, and a vibration transmitting plate 223 that are disposed along the first central axis X. The voice coil assembly 221 and the magnet assembly 222 are disposed within a cylindrical space of the cylindrical cover 210. The vibration transmitting plate 223 is fixedly connected to one of the magnet assembly 222 and the voice coil assembly 221, and is also fixedly connected to the cylindrical cover 210. The other one of the magnet assembly 222 and the voice coil assembly 221 is fixedly connected to the cylindrical cover 210. The cylindrical cover 210 blocks the communication hole 113.

The magnet assembly 222 is configured to interact with a magnetic field of the voice coil assembly 221 to generate vibration when a current passes through the voice coil assembly 221. The magnet assembly 222 converts a current signal related to sound into a vibration signal. The voice coil assembly 221 is configured to generate the electrical signal that interacts with the magnetic field of the magnet assembly 222 when the current passes through the voice coil assembly 221. This causes the magnet assembly 222 to generate vibration. The cylindrical cover 210 may be a magnetic shield. The cylindrical cover 210 may be configured to constrain a magnetic field direction of the magnet assembly 222. The cylindrical cover 210 may also be configured to contact the housing assembly 100. When the voice coil assembly 221 vibrates, the voice coil assembly 221 may drive the cylindrical cover 210 to vibrate, thereby transmitting the vibration signal to the housing assembly 100. The vibration transmitting plate 223 may be configured to elastically connect the voice coil assembly 221 and the magnet assembly 222, and may elastically constrain a relative movement of the voice coil assembly 221 and the magnet assembly 222 along the direction of the first central axis X.

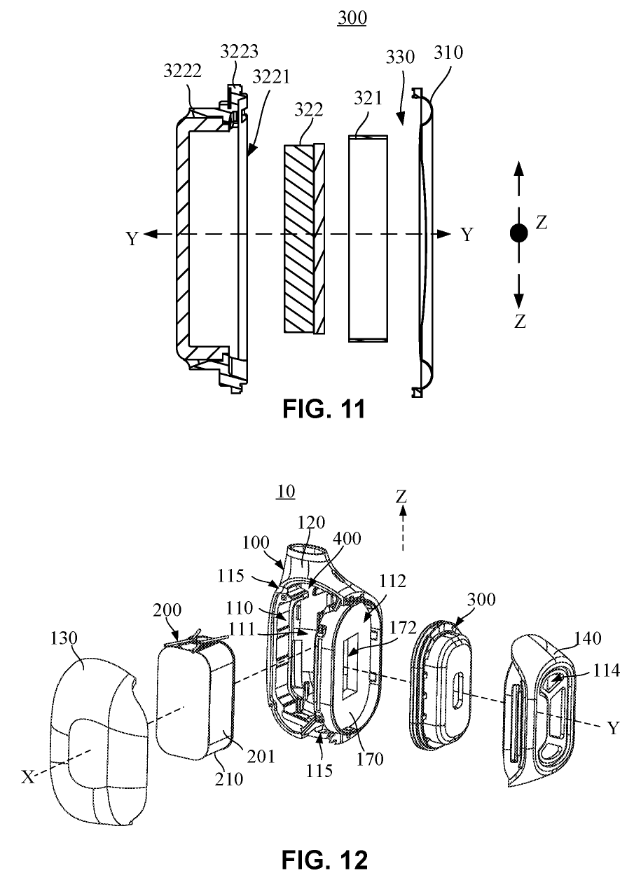

In some embodiments, as shown in FIG. 10 to FIG. 11, the air conduction speaker 300 includes the diaphragm 310 and the driving mechanism 320. The driving mechanism 320 is connected to the diaphragm 310. The internal acoustic cavity 330 is enclosed between the diaphragm 310 and the driving mechanism 320. The driving mechanism 320 is configured to drive the diaphragm 310 to generate vibration under control of the electrical signal. This causes air in the internal acoustic cavity 330 of the air conduction speaker 300 to vibrate and generate the sound waves.

There are various manners to arrange the air conduction speaker 300 within the second accommodation cavity 112. For example, the internal acoustic cavity 330 may be in communication with the second sub-cavity 1122 to be in communication with the pressure relief hole 115. Alternatively, the internal acoustic cavity 330 is in communication with the first sub-cavity 1121. Two manners to arrange the air conduction speaker 300 within the second accommodation cavity 112 are illustrated below.

In the first manner, the diaphragm 310 may be disposed closer to the communication hole 113 than the driving mechanism 320. The diaphragm 310 is disposed opposite to the communication hole 113 and faces the second sub-cavity 1122. The first sub-cavity 1121 may be in communication with the internal acoustic cavity 330.

When the driving mechanism 320 drives the diaphragm 310 to generate vibration, the diaphragm 310 is relatively close to the communication hole 113, i.e., relatively close to the bone conduction speaker 200. On one hand, as a radial size of the diaphragm 310 is relatively large, and the radial size of the driving mechanism 320 is relatively small, disposing the diaphragm 310 with the greater size close to the bone conduction speaker 200 and disposing the driving mechanism 320 with the smaller size close to an outer side can effectively reduce a volume of the housing assembly 100 near the outer side, and make the volume and the size of the speaker assembly 10 more compact and reasonable, thereby improving the utilization of an internal space of the speaker assembly 10. On the other hand, the diaphragm 310 is disposed opposite to the communication hole 113 and faces the second sub-cavity 1122, which effectively increases the volume of the second sub-cavity 1122. The air in the second sub-cavity 1122 is effectively conducted to the outside through the pressure relief hole 115, thereby improving the pressure relief effect.

In the second manner, the diaphragm 310 may be disposed farther from the communication hole 113 than the driving mechanism 320. The diaphragm 310 may be opposite to the communication hole 113 and face the first sub-cavity 1121. The second sub-cavity 1122 communicates with the internal acoustic cavity 330.

By disposing the diaphragm 310 to be opposite to the communication hole 113 and face the first sub-cavity 1121, the sound waves generated by the diaphragm 310 may be conveniently transmitted to the first sub-cavity 1121. Moreover, because of the existence of the communication hole 113 and the second sub-cavity 1122, the internal acoustic cavity 330 is equivalently enlarged, and the pressure relief is performed through the pressure relief hole 115, which effectively improves the pressure relief effect.

In some embodiments, as shown in FIG. 10 to FIG. 11, the driving mechanism 320 includes a voice coil 321 and a magnetic circuit assembly 322. The magnetic circuit assembly 322 includes a cover 3222 with an open end 3221 and an annular flange 3223 disposed at the open end 3221 of the cover 3222 and protruding from an outer peripheral surface of the cover 3222. The magnetic circuit assembly 322 is configured to interact with the voice coil 321 to generate vibration. The voice coil 321 is configured to drive the magnetic circuit assembly 322 to generate vibration through an interaction with the magnetic field of the magnetic circuit assembly 322 when the current passes through the voice coil 321.

An edge of the diaphragm 310 may be fixed to the annular flange 3223. The voice coil 321 may be connected to a side of the diaphragm 310 facing the magnetic circuit assembly 322. The diaphragm 310 and the magnetic circuit assembly 322 may enclose to form the internal acoustic cavity 330. The diaphragm 310 may be located on a side of the cover 3222 opposite to the sound output hole 114 and faces the communication hole 113. The first sub-cavity 1121 communicates with the internal acoustic cavity 330. Disposing the first sub-cavity 1121 to communicate with the internal acoustic cavity 330 allows the sound waves generated by air vibration inside the internal acoustic cavity 330 to spread out of the speaker assembly 10 through the first sub-cavity 1121 and the sound output hole 114.

Optionally, the annular flange 3223 may be disposed on a side opposite to the sound output hole 114, and the diaphragm 310 may be disposed on the side opposite to the sound output hole 114. In this way, the diaphragm 310 and the annular flange 3223 are disposed relatively close to an interior of the housing assembly 100, thereby allowing the air conduction speaker 300 to be provided with a relatively large radial-sized diaphragm 310, and the annular flange 3223 is arranged away from the sound outlet hole 114, while the smaller-sized portions of the air conduction speaker 300 can be arranged close to the sound outlet hole 114. Compared with a conventional structure where the diaphragm 310 of the speaker must face the sound output hole 114, this reversely disposed structure of the air conduction speaker 300 can effectively reduce the size of a portion of the housing assembly 100 near the sound output hole 114. This allows the size of the housing assembly 100 to decrease in a region from a middle region to a portion region of the sound output hole 114 (i.e., a radial size of an outer peripheral surface of the housing assembly 100 can be gradually reduced), thereby making the structure more compact, effectively improving the space utilization of the housing assembly 100, and reducing an overall volume of the entire housing assembly 100. Moreover, this reversely disposed structure may optimize a sound output path, thereby improving the sound quality. In short, the air conduction speaker 300 is reversely disposed along an air conduction vibration direction, thereby effectively reducing the structural size of the housing assembly 100.

In the speaker assembly 10, if the sound output hole 114 and the pressure relief hole 115 are relatively close to each other, the sound waves respectively generated by the pressure relief hole 115 and the sound output hole 114 may interfere with each other, and a near-field interference may occur. A low-frequency sound wave transmitted by the sound output hole 114 is easily weakened under reverse-phase interference of the sound wave discharged during the pressure relief at the pressure relief hole 115, thereby generating a sound cancellation phenomenon. Related technical means for the pressure relief hole 115 and the sound output hole 114 are further described in the following embodiments.

The following is an exemplary description of the earphone 1 according to another embodiment.

As mentioned above, the housing assembly 100 may be disposed with the accommodation space 110. The air conduction speaker 300 is disposed in the accommodation space 110. The bone conduction speaker 200 is disposed in the accommodation space 110.

Optionally, the bone conduction speaker 200 has the first central axis X and is capable of generating vibration along the direction of the first central axis X. The air conduction speaker 300 has the second central axis Y and is capable of generating vibration along the direction of the second central axis Y. Specifically, the voice coil and the diaphragm of the air conduction speaker 300 generate vibration in the direction of the second central axis Y.

The housing assembly 100 is further disposed with the sound output hole 114 and the pressure relief hole 115 that are in communication with the accommodation space 110. The sound output hole 114 and the pressure relief hole 115 are respectively configured to conduct a portion of the sound waves generated by the air conduction speaker 300 to the external environment. The pressure relief hole 115 and the sound output hole 114 are respectively located on two opposite side surfaces of the housing assembly 100.

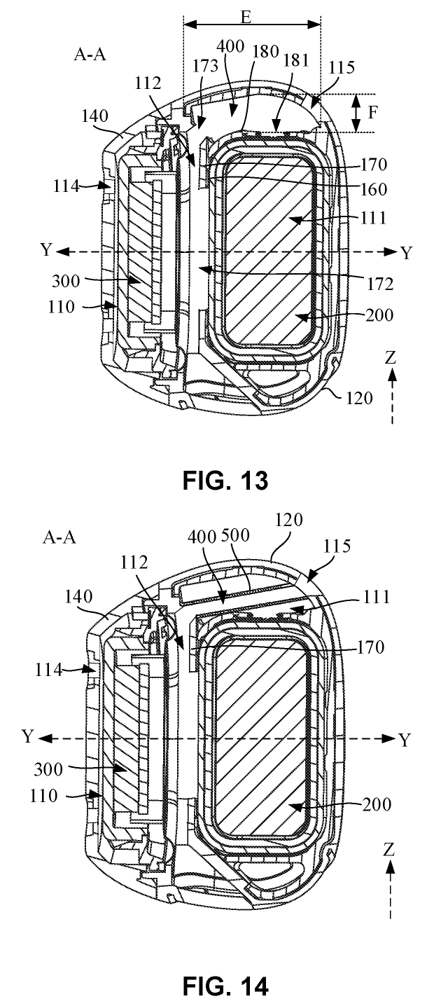

As shown in FIGS. 12-13, the housing assembly 100 may include the first housing 120, the second housing 130, and the third housing 140. The first housing 120, the second housing 130, and the third housing 140 may collectively enclose to form the accommodation space 110. Optionally, the second housing 130 may be connected to the first housing 120 along the direction of the first central axis X. The third housing 140 may be connected to the second housing 130 along the direction of the second central axis Y. Optionally, the sound output hole 114 may be disposed in the third housing 140. The pressure relief hole 115 may be disposed in a portion of the first housing 120 opposite to the third housing 140, so that the sound output hole 114 and the pressure relief hole 115 are respectively located on the two opposite side surfaces of the housing assembly 100.

By disposing the sound output hole 114 and the pressure relief hole 115 on the two opposite side surfaces of the housing assembly 100, compared to disposing the sound output hole 114 and the pressure relief hole 115 on other adjacent or the same side surfaces of the housing assembly 100, a distance between the sound output hole 114 and the pressure relief hole 115 may be increased to reduce a mutual influence between the sound output hole 114 and the pressure relief hole 115, reduce the near-field interference cancellation between the sound output hole 114 and the pressure relief hole 115 (which weakens the sound waves transmitted from the sound output hole 114), thereby attenuating the sound cancellation phenomenon between the sound output hole 114 and the pressure relief hole 115, improving a low-frequency effect of the speaker assembly 10, and thereby improving the sound quality effect of the earphone 1.

In some embodiments, as shown in FIG. 12 to FIG. 13, the speaker assembly 10 is provided with a pressure relief channel 400 communicating with the pressure relief hole 115. The sound output hole 114 may communicate with the accommodation space 110. The pressure relief channel 400 is configured to guide a portion of the sound waves generated by the air conduction speaker 300 in the accommodation space 110 to the pressure relief hole 115.

By disposing the pressure relief channel 400 that communicates the accommodation space 110 and the pressure relief hole 115, the air in the accommodation space 110 that requires pressure relief may be conveniently guided into the pressure relief channel 400, and further relieved through the pressure relief hole 115. On one hand, the pressure relief path may be extended to improve the pressure relief effect. On the other hand, the pressure relief channel 400 communicates with the pressure relief hole 115, which makes the sound wave that requires pressure relief less likely to affect the operation of other components during the pressure relief process, thereby improving the sound quality effect of the speaker assembly 10. By disposing the pressure relief channel 400, a precise positioning of the pressure relief for the air conduction speaker 300 is realized, which reduces the mutual influence between the sound output hole 114 and the pressure relief hole 115, and the flexibility of the pressure relief for the air conduction speaker 300 is improved.

In some embodiments, the pressure relief channel 400 and the accommodation space 110 are spaced apart from each other, and the pressure relief channel 400 communicates with the accommodation space 110. Optionally, the first housing 120 may be disposed with the pressure relief channel 400. One end of the pressure relief channel 400 communicates with the accommodation space 110, and another end of the pressure relief channel 400 forms the pressure relief hole 115. Specifically, the pressure relief channel 400 and the accommodation space 110 are spaced apart from each other, so that the air to be pressure-relieved is independently pressure-relieved and spaced apart from other components in the accommodation space 110, thereby making the pressure relief less likely to affect the components in the accommodation space 110. Furthermore, by disposing the pressure relief channel 400 in the first housing 120, on one hand, the distance between the pressure relief hole 115 and the sound output hole 114 may be made relatively large. On the other hand, when the first housing 120, the second housing 130, and the third housing 140 are assembled, no additional assembly for the pressure relief channel 400 is required, thereby improving the assembly efficiency.

In some embodiments, as shown in FIG. 12 to FIG. 13, the accommodation space 110 includes the first accommodation cavity 111 and the second accommodation cavity 112 that are separated from each other. The bone conduction speaker 200 is disposed in the first accommodation cavity 111. The air conduction speaker 300 is disposed in the second accommodation cavity 112. The sound output hole 114 communicates with the second accommodation cavity 112. The pressure relief channel 400 communicates with the second accommodation cavity 112, and is spaced apart from the first accommodation cavity 111. The pressure relief channel 400 communicates the second accommodation cavity 112 with the pressure relief hole 115.

Optionally, the second housing 130 and the first housing 120 are cooperatively connected to form the first accommodation cavity 111. The third housing 140 and the first housing 120 are cooperatively connected to form the second accommodation cavity 112.

As working principles of the bone conduction speaker 200 and the air conduction speaker 300 are different, by spacing the first accommodation cavity 111, the second accommodation cavity 112, and the pressure relief channel 400 apart from each other, an independence of the operation of the bone conduction speaker 200 may be ensured, an influence of the operation of the air conduction speaker 300 on the bone conduction speaker 200 may be minimized, and the bone conduction speaker 200 may also be protected to a certain extent. As during the operation of the earphone 1, the sound waves generated by the air conduction speaker 300 through the air vibration principle may spread out of the speaker assembly 10 through the sound output hole 114 to spread into the ear canal of the user, communicating the second accommodation cavity 112, where the air conduction speaker 300 is located, with the external environment through the pressure relief hole 115 allows the air to flow freely in the second accommodation cavity 112 and the air conduction speaker 300, thereby preventing the air in the second accommodation cavity 112 from generating damping on the vibration of the air conduction speaker 300 and affecting the sound quality effect generated by the air conduction speaker 300.

In some embodiments, the first accommodation cavity 111 and the second accommodation cavity 112 are separated from each other. Specifically, an area of a communication portion between the first accommodation cavity 111 and the external environment is smaller than an area of a communication portion between the second accommodation cavity 112 and the external environment, and an area of a communication portion between the pressure relief channel 400 and the external environment. In other words, the impermeability of the first accommodation cavity 111 is stronger than the impermeabilities of the second accommodation cavity 112 and the pressure relief channel 400. The impermeability may be understood as the air tightness of the cavity space.

As the bone conduction speaker 200 requires an environment with a strong impermeability to ensure the bone conduction effect, the bone conduction speaker 200 and the air conduction speaker 300 are respectively and independently disposed in two different cavities of the accommodation space 110, to effectively reduce the mutual interference between the bone conduction speaker 200 and the air conduction speaker 300. Moreover, disposing the bone conduction speaker 200 in the first accommodation cavity 111 with a better impermeability may also effectively improve the sound quality effect generated by the bone conduction speaker 200.

Optionally, in the vertical direction Z perpendicular to an arrangement direction of the first accommodation cavity 111 and the second accommodation cavity 112, the pressure relief channel 400 and the first accommodation cavity 111 are spaced apart. As shown in FIG. 12 to FIG. 13, the arrangement direction of the first accommodation cavity 111 and the second accommodation cavity 112 may be consistent with the direction of the second central axis Y of the air conduction speaker 300, which are both the direction indicated by the line Y in FIG. 12 and FIG. 13. The vertical direction Z perpendicular to the arrangement direction of the first accommodation cavity 111 and the second accommodation cavity 112 is indicated by the arrow Z in FIG. 12 and FIG. 13.

Optionally, a length component of an extension length of the pressure relief channel 400 along the arrangement direction is greater than a length component of the pressure relief channel 400 along the vertical direction Z. Such a configuration may allow the pressure relief channel 400 to occupy a smaller size in the vertical direction Z, thereby reducing a size of the speaker assembly 10 in the vertical direction Z. This configuration may also allow a distance between the sound output hole 114 and the pressure relief hole 115 to be relatively great, thereby reducing the mutual influence between the sound output hole 114 and the pressure relief hole 115 in the near-field. In the configuration, the length component of the extension length of the pressure relief channel 400 along the arrangement direction is shown as a length E in FIG. 13, and the length component of the pressure relief channel 400 along the vertical direction Z is shown as a length F in FIG. 13, where E > F.

In some embodiments, as shown in FIG. 12 to FIG. 13, the housing assembly 100 is provided with a first partition wall 170 between the first accommodation cavity 111 and the second accommodation cavity 112, and is provided a second partition wall 180 between the pressure relief channel 400 and the first accommodation cavity 111. The first partition wall 170 may separate the second accommodation cavity 112 from the first accommodation cavity 111. The second partition wall 180 may be configured to separate the pressure relief channel 400 from the first accommodation cavity 111. Such a configuration may form an independent pressure relief channel 400 and an independent first accommodation cavity 111. On one hand, the existence of the pressure relief channel 400 may extend the pressure relief path, increase the size of a pressure relief space, and improve the pressure relief effect, thereby improving the sound quality. On the other hand, the operation process of the air conduction speaker 300 and the operation process of the bone conduction speaker 200 may not interfere with each other, thereby reducing the mutual influence between the air conduction speaker 300 and the bone conduction speaker 200, and ensuring respective sound quality output effects.

Optionally, one end of the second partition wall 180 may be connected to the first housing 120, and the opposite end of the second partition wall 180 may be connected to the first partition wall 170, so that the pressure relief channel 400 and the first accommodation cavity 111 are arranged spaced apart in the vertical direction Z.

Optionally, as shown in FIG. 13, the first partition wall 170 may further extend between the second accommodation cavity 112 and the pressure relief channel 400. The first partition wall 170 may be provided with a sound guiding hole 173. The sound guiding hole 173 communicates the second accommodation cavity 112 with the pressure relief channel 400. The pressure relief hole 115 communicates with the second accommodation cavity 112 through the pressure relief channel 400 and the sound guiding hole 173. During the operation of the earphone 1, a portion of the sound waves generated by the air conduction speaker 300 that require to be relieved may sequentially spread out of the speaker assembly 10 through the second accommodation cavity 112, the sound guiding hole 173, the pressure relief channel 400, and the pressure relief hole 115, thereby preventing the air in the second accommodation cavity 112 from damping the vibration of the air conduction speaker 300 and affecting the sound quality effect generated by the air conduction speaker 300.

In some embodiments, as shown in FIG. 13, the housing assembly 100 is provided with a first communication hole 172 between the first accommodation cavity 111 and the second accommodation cavity 112. The first communication hole 172 communicates the first accommodation cavity 111 with the second accommodation cavity 112. The bone conduction speaker 200 may block the first communication hole 172, so that the first accommodation cavity 111 and the second accommodation cavity 112 are separated from each other.

Providing the first communication hole 172 between the first accommodation cavity 111 and the second accommodation cavity 112 and using the bone conduction speaker 200 to block the first communication hole 172 on one side of the first communication hole 172 may expand the usable space of the first accommodation cavity 111 while ensuring a strong impermeability of the second accommodation cavity 112. This configuration may effectively improve the convenience of assembling the air conduction speaker 300 and the reliability of the structural arrangement. This configuration may also simply and effectively increase the volume of an acoustic cavity space formed by the air conduction speaker 300 in the second accommodation cavity 112, improve the sound output effect of the air conduction speaker 300, and improve the sound quality of the air conduction speaker 300. From another perspective, when the volume of the acoustic cavity space is kept unchanged, the air conduction speaker 300 may be arranged closer to the side of the bone conduction speaker 200, which reduces the size of the speaker assembly 10 and achieves the compactness of an overall size.

In some embodiments, as shown in FIG. 13, the housing assembly 100 is provided with a second communication hole 181 between the first accommodation cavity 111 and the pressure relief channel 400. The second communication hole 181 communicates the first accommodation cavity 111 with the pressure relief channel 400. The bone conduction speaker 200 blocks the second communication hole 181, so that the first accommodation cavity 111 and the pressure relief channel 400 are separated from each other.

Similarly, providing the second communication hole 181 to communicate the first accommodation cavity 111 with the pressure relief channel 400 and arranging the bone conduction speaker 200 to block the second communication hole 181 may increase an area of the pressure relief channel 400 while ensuring the strong impermeability of the first accommodation cavity 111. This configuration may allow the pressure relief channel 400 to have a relatively large space for pressure relief, thereby improving the pressure relief effect. Alternatively, this configuration may allow the pressure relief channel 400 to be arranged relatively close to the first accommodation cavity 111 while ensuring the size of the area, thereby reducing the size of the speaker assembly 10 in the vertical direction Z.

Certainly, in other embodiments, the pressure relief channel 400 may be configured in other forms. Other forms of the pressure relief channel 400 are exemplarily described below.

In some embodiments, as shown in FIG. 14, the speaker assembly 10 includes a channel tube 500 formed with the pressure relief channel 400. The channel tube 500 is fixedly arranged on the housing assembly 100 and located in the first accommodation cavity 111. One end of the channel tube 500 communicates with the second accommodation cavity 112, and the other end of the channel tube 500 communicates with the pressure relief hole 115.

Optionally, the first partition wall 170 may be provided between the first accommodation cavity 111 and the second accommodation cavity 112. The first partition wall 170 may separate the second accommodation cavity 112 from the first accommodation cavity 111. One end of the channel tube 500 may be connected to the first partition wall 170 to communicate with the second accommodation cavity 112, and the other end of the channel tube 500 may communicate with the pressure relief hole 115 on the first housing 120, thereby communicating the second accommodation cavity 112 with the external environment. Optionally, the bone conduction speaker 200 may be arranged spaced apart from the channel tube 500 in the vertical direction Z.

The channel tube 500 is arranged in the first accommodation cavity 111 and is separated from the first accommodation cavity 111, and the channel tube 500 and the first accommodation cavity 111 do not communicate with each other. Specifically, a portion of the channel tube 500 communicating with the second accommodation cavity 112 is sealed relative to the first accommodation cavity 111, and a portion of the channel tube 500 communicating with the pressure relief hole 115 is also sealed relative to the first accommodation cavity 111. Specifically, the channel tube 500 is sealingly connected to the first housing 120 within the first accommodation cavity 111, and thus does not communicate with the first accommodation cavity 111. This configuration may ensure the strong impermeability of the first accommodation cavity 111, thereby ensuring the bone conduction effect of the bone conduction speaker 200.

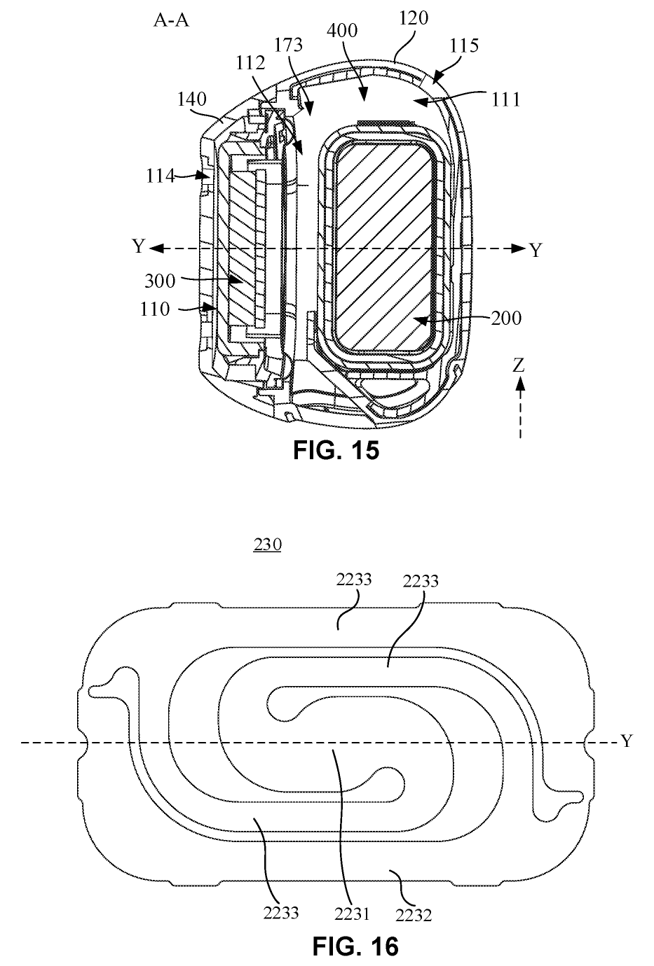

In other embodiments, as shown in FIG. 15, a portion of the accommodation space 110 forms the pressure relief channel 400.

Optionally, the bone conduction speaker 200 may be configured as a sealed structure, and the interior of the bone conduction speaker 200 is separated from the accommodation space 110. The pressure relief channel 400 may be disposed between the bone conduction speaker 200 and an inner wall of the accommodation space 110. Because the bone conduction speaker 200 is a sealed structure, the bone conduction speaker 200 may minimize the influence of moisture in the accommodation space 110 on the bone conduction speaker 200. This configuration may also allow the bone conduction speaker 200 to adapt to a non-sealed environment, and the bone conduction speaker 200 may produce a good bone conduction effect without requiring a strong impermeability.

Optionally, as shown in FIG. 15, the accommodation space 110 includes the first accommodation cavity 111 and the second accommodation cavity 112 spaced apart from each other. The bone conduction speaker 200 may be arranged in the first accommodation cavity 111, and the pressure relief channel 400 may be disposed between the bone conduction speaker 200 and the inner wall of the first accommodation cavity 111. The air conduction speaker 300 may be arranged in the second accommodation cavity 112. The housing assembly 100 is provided with a sound guiding hole 173 between the first accommodation cavity 111 and the second accommodation cavity 112. The sound guiding hole 173 communicates the first accommodation cavity 111 with the second accommodation cavity 112.

Specifically, the pressure relief hole 115 is provided on the first housing 120 and communicates with the first accommodation cavity 111. Then, the sound waves generated by the air conduction speaker 300 that need to be released may be discharged out of the speaker assembly 10 sequentially through the second accommodation cavity 112, the sound guiding hole 173, the first accommodation cavity 111 (i.e., the pressure relief channel 400), and the pressure relief hole 115.

Thus, by enclosing the pressure relief channel 400 with the bone conduction speaker 200 and the inner wall of the first accommodation cavity 111, the internal structure of the first accommodation cavity 111 can be simplified, the size of the first accommodation cavity 111 can be reduced, thereby making the structure of the speaker assembly 10 more compact. Moreover, using the first accommodation cavity 111 and the bone conduction speaker 200 to form the pressure relief channel may improve the space utilization of the first accommodation cavity 111, thereby fully utilizing the space of the first accommodation cavity 111 to increase the size of the pressure relief channel 400, improving the pressure relief effect, and improving the sound quality effect of the air conduction speaker 300.

In some embodiments, as shown in FIG. 8 to FIG. 9, the bone conduction speaker 200 includes a cylindrical cover 210, a driving assembly 220, and two sealing plates 230. The cylindrical cover 210 may be fixedly connected to the housing assembly 100. The driving assembly 220 is arranged in the cylindrical cover 210. The driving assembly 220 is configured to drive the cylindrical cover 210 to vibrate, thereby driving the housing assembly 100 to vibrate. The two sealing plates 230 may be respectively arranged at two ends of the cylindrical cover 210 and block the cylindrical cover 210 to form the sealed structure.

Optionally, the driving assembly 220 is arranged between the two sealing plates 230, and the driving assembly 220 and the two sealing plates 230 are sequentially arranged in the direction of the first central axis X. The driving assembly 220 is configured to generate the vibration in the direction of the first central axis X under an action of the current signal, to drive the cylindrical cover 210 and drive the housing assembly 100 to vibrate, thereby transmitting the vibration signal to a human body in contact with the housing assembly 100, thus realizing the bone conduction function.

By arranging the two sealing plates 230 to block the cylindrical cover 210, the sealed structure of the bone conduction speaker 200 is achieved, thereby reducing the interference from external moisture and dust on the bone conduction speaker 200. This configuration also makes the structure of the bone conduction speaker 200 more integrated, thereby improving the structural compactness. Optionally, the sealing plate 230 may be configured as a magnetic conductive plate, which suppresses a magnetic flux leakage of the driving assembly 220, thereby increasing a magnetic field intensity inside the cylindrical cover 210.

In some embodiments, as shown in FIG. 8 to FIG. 9, the bone conduction speaker 200 further includes the vibration transmitting plate 223. The driving assembly 220 may further include the voice coil assembly 221 and the magnet assembly 222. The voice coil assembly 221 may be sleeved on the magnet assembly 222. The vibration transmitting plate 223 may be fixedly connected to the cylindrical cover 210 and one of the voice coil assembly 221 and the magnet assembly 222. The other one of the voice coil assembly 221 and the magnet assembly 222 may be fixedly connected to the cylindrical cover 210.

In this configuration, the magnet assembly 222 is configured to, when the current passes through the voice coil assembly 221, interact with the magnetic field of the magnet assembly 222 with the voice coil assembly 221, thereby generating vibration to convert the current signal related to sound into the vibration signal. The voice coil assembly 221 is configured to, when the current passes through the voice coil assembly 221, generate the electrical signal to interact with the magnetic field of the magnet assembly 222, thereby generating vibration. The cylindrical cover 210 is configured to constrain the magnetic field direction of the magnet assembly 222. The cylindrical cover 210 is also configured to contact the housing assembly 100. When the voice coil assembly 221 vibrates, the voice coil assembly 221 may drive the cylindrical cover 210 to vibrate, thereby transmitting the vibration signal to the housing assembly 100 through the cylindrical cover 210. The vibration transmitting plate 223 may be configured to elastically connect the voice coil assembly 221 and the magnet assembly 222, so as to elastically constrain the voice coil assembly 221 and the magnet assembly 222 to perform the relative movement in the direction of the first central axis X.

The following embodiments further describe a sealed structure of the bone conduction speaker 200 by way of example.

Referring to FIG. 3A, the bone conduction speaker 200 is disposed in the accommodation space 110. The bone conduction speaker 200 is connected to the housing assembly 100. Specifically, when the earphone 1 is in use, the housing assembly 100 fits the human body of the user, and the bone conduction speaker 200 is configured to drive the housing assembly 100 to vibrate in a bone conduction vibration manner to transmit sound to the user.

In some embodiments, as shown in FIG. 8 to FIG. 9, the bone conduction speaker 200 includes the cylindrical cover 210, the driving assembly 220, and the two sealing plates 230. The cylindrical cover 210 is enclosed to form an accommodation space 211. The driving assembly 220 is disposed in the accommodation space 211 and is connected to the cylindrical cover 210. The two sealing plates 230 are respectively disposed at two ends of the cylindrical cover 210 and seal the accommodation space 211.

The driving assembly 220 is configured to convert the current signal into a vibration signal, such that when the bone conduction speaker 200 is in use, the driving assembly 220 generates vibration to drive the cylindrical cover 210 to vibrate. The two sealing plates 230 seal the two ends of the cylindrical cover 210, such that the accommodation space 211 where the driving assembly 220 is located forms the sealed space, thereby limiting the driving assembly 220 and preventing the driving assembly 220 from falling out of the cylindrical cover 210. Moreover, sealing the cylindrical cover 210 with the two sealing plates 230 may also prevent impurities such as dust and water droplets from entering the accommodation space 211 and affecting the vibration of the driving assembly 220, thereby ensuring the bone conduction effect of the bone conduction speaker 200 and extending the service life of the bone conduction speaker 200. Moreover, the structure of the bone conduction speaker 200 is more integrated, and the compactness of the structure is improved.

Optionally, the sealing plate 230 may be configured as a magnetic conductive plate, which suppresses the magnetic flux leakage of the driving assembly 220, thereby increasing the magnetic field strength inside the cylindrical cover 210. For example, the sealing plate 230 is a steel plate. In some embodiments, the sealing plate 230 is an ordinary metal plate.

In some embodiments, as shown in FIG. 8 to FIG. 9, the bone conduction speaker 200 further includes the vibration transmitting plate 223, and the vibration transmitting plate 223 connects the driving assembly 220 and the cylindrical cover 210. In the central axis direction of the cylindrical cover 210, the vibration transmitting plate 223 is disposed between the driving assembly 220 and the sealing plate 230, and is arranged opposite to the sealing plate 230. Specifically, a central axis of the cylindrical cover 210 may coincide with the first central axis X of the bone conduction speaker 200, and the central axis direction of the cylindrical cover 210 is shown by an arrow X in FIG. 8 and FIG. 9.

The vibration transmitting plate 223 is configured to connect to the driving assembly 220 to limit the driving assembly 220, and the driving assembly 220 drives the cylindrical cover 210 to vibrate by driving the vibration transmitting plate 223 during vibration. Specifically, in the central axis direction of the cylindrical cover 210, the sealing plate 230, the vibration transmitting plate 223, and the driving assembly 220 are arranged in sequence. The vibration direction of the bone conduction speaker 200 may also be the central axis direction of the cylindrical cover 210, that is, the vibration direction of the driving assembly 220 is also the central axis direction of the cylindrical cover 210. With such arrangement, when the driving assembly 220 is vibrating in operation, the sealing plate 230 and the vibration transmitting plate 223 may directly provide a dual limitation to the driving assembly 220 in the vibration direction of the driving assembly 220, and the sealing plate 230 may also limit the vibration transmitting plate 223, thereby preventing an excessive deformation of the vibration transmitting plate 223 during the vibration in operation of the driving assembly 220, thus improving the service life of the vibration transmitting plate 223.

In some embodiments, as shown in FIG. 8 to FIG. 9, the two sealing plates 230 are fixedly connected to the two ends of the cylindrical cover 210, and the periphery of the vibration transmitting plate 223 is fixed to an inner wall of the cylindrical cover 210.

Optionally, as shown in FIG. 8 to FIG. 9, at least one end of the cylindrical cover 210 may be configured in a stepped shape to form a first supporting surface 212 and a second supporting surface 213 with a step difference in the central axis direction, and the second supporting surface 213 is closer to the central axis of the cylindrical cover 210 than the first supporting surface 212. The sealing plate 230 is fixedly supported on the first supporting surface 212. The periphery of the vibration transmitting plate 223 is fixedly supported on the second supporting surface 213.

Optionally, the first supporting surface 212 may be flush with a surface of the vibration transmitting plate 223 opposite to the second supporting surface 213, such that when the sealing plate 230 is fixedly supported on the first supporting surface 212, the sealing plate 230 presses the vibration transmitting plate 223 against the second supporting surface 213 to further fix the vibration transmitting plate 223 to the cylindrical cover 210. Such an arrangement may make the structure of the bone conduction speaker 200 more compact and also facilitate assembly and installation.

The connection between the sealing plate 230 and the first supporting surface 212 may be sealed (e.g., the sealant is applied for fixation and sealing, or a welding manner is used for fixation and sealing), and another sealing plate 230 disposed at another end of the cylindrical cover 210 may also be sealed with the cylindrical cover 210, such that the cylindrical cover 210 presents as a sealed structure.

In some other embodiments, the vibration transmitting plate 223 is fixedly connected to one end of the cylindrical cover 210, and the sealing plate 230 is fixedly stacked on a side of the vibration transmitting plate 223 away from the driving assembly 220 and is spaced apart from the cylindrical cover 210.

Specifically, in an axial direction of the cylindrical cover 210, the sealing plate 230, the vibration transmitting plate 223, and the cylindrical cover 210 are arranged in a stacked manner, a periphery of the vibration transmitting plate 223 is fixedly connected to an end surface of the cylindrical cover 210, and the sealing plate 230 is fixed to the vibration transmitting plate 223 and thus connected to the cylindrical cover 210 via the vibration transmitting plate 223. Both the connection between the vibration transmitting plate 223 and the cylindrical cover 210 and the connection between the sealing plate 230 and the vibration transmitting plate 223 are sealed.

Certainly, in some other embodiments, the vibration transmitting plate 223 and the sealing plate 230 is also fixed relative to the cylindrical cover 210 in other manners. For example, the periphery of the vibration transmitting plate 223 is directly connected to the inner wall of the cylindrical cover 210, and the sealing plate 230 is fixedly supported on the first supporting surface 212 to cover one end of the cylindrical cover 210. This embodiment does not list all possibilities here.

In some embodiments, as shown in FIG. 8 to FIG. 9, there are two vibration transmitting plates 223 respectively fixedly connected to the cylindrical cover 210, and the two sealing plates 230 are correspondingly disposed on sides of the two vibration transmitting plates 223 away from the driving assembly 220.

Specifically, the two vibration transmitting plates 223 and the two sealing plates 230 are arranged in sequence along the central axis direction of the cylindrical cover 210. Moreover, the two vibration transmitting plates 223 and the two sealing plates 230 are respectively located on two sides of the driving assembly 220, and the two vibration transmitting plates 223 connect the driving assembly 220 and the cylindrical cover 210 on the two sides of the driving assembly 220 to limit the driving assembly 220 on the two sides. The two sealing plates 230 are respectively disposed on sides of the two vibration transmitting plates 223 away from the driving assembly 220 to protect the two vibration transmitting plates 223 and to seal the accommodation space 211 of the cylindrical cover 210.

Providing the two vibration transmitting plates 223 facilitates the driving assembly 220 to drive the cylindrical cover 210 to vibrate by driving the two vibration transmitting plates 223 during vibration, thereby improving the bone conduction effect of the bone conduction speaker 200, increasing the sensitivity of the bone conduction speaker 200. Moreover, limiting the driving assembly 220 may also share the pressure caused by vibration of the driving assembly 220, thereby improving the service life of the vibration transmitting plate 223 and further improving the service life of the bone conduction speaker 200.

Certainly, in some other embodiments, there is one vibration transmitting plate 223, and the vibration transmitting plate 223 is disposed on one side of the cylindrical cover 210 and connected to the driving assembly 220 to limit the driving assembly 220. The two sealing plates 230 may also be disposed on two sides of the cylindrical cover 210 and seal the accommodation space 211 of the cylindrical cover 210, and the vibration transmitting plate 223 is located between the two sealing plates 230 and within the accommodation space 211 of the cylindrical cover 210. Optionally, the sealing plate 230 on a side away from the vibration transmitting plate 223 may be integrally formed with the cylindrical cover 210 to form an integral structure, thereby improving the impermeability of the accommodation space 211.

In some embodiments, as shown in FIG. 8 to FIG. 9, the driving assembly 220 further includes a voice coil assembly 221 and a magnet assembly 222. A first one of the voice coil assembly 221 and the magnet assembly 222 surrounds a second one of the voice coil assembly 221 and the magnet assembly 222, and the first one of the voice coil assembly 221 and the magnet assembly 222 is fixedly connected to the cylindrical cover 210. The vibration transmitting plate 223 fixedly connects the second one of the voice coil assembly 221 and the magnet assembly 222 to the cylindrical cover 210. The vibration transmitting plate 223 and the sealing plate 230 are arranged opposite to each other in the central axis direction, and the vibration transmitting plate 223 is configured to elastically constrain a relative movement of the voice coil assembly 221 and the magnet assembly 222 along the central axis direction of the cylindrical cover 210. The voice coil assembly 221 is configured to receive a current, and the current may form a current loop through the voice coil assembly 221. The magnet assembly 222 is configured to interact with the current in the voice coil assembly 221 to generate vibration in the central axis direction. The magnet assembly 222 directly or indirectly drives the cylindrical cover 210 to move during vibration. The magnet assembly 222 and the voice coil assembly 221 move relative to each other along the central axis direction of the cylindrical cover 210.

For example, in the embodiment shown in FIG. 8 and FIG. 9, the first one of the voice coil assembly 221 and the magnet assembly 222 is the voice coil assembly 221, and the second one of the voice coil assembly 221 and the magnet assembly 222 is the magnet assembly 222. Specifically, the voice coil assembly 221 is disposed on the inner wall of the cylindrical cover 210 and fixedly connected to the cylindrical cover 210, the voice coil assembly 221 surrounds the magnet assembly 222, the magnet assembly 222 is disposed in the accommodation space 211 of the cylindrical cover 210 and spaced apart from the voice coil assembly 221, and the vibration transmitting plate 223 fixedly connects the magnet assembly 222 to the cylindrical cover 210. The magnet assembly 222, the vibration transmitting plate 223, and the sealing plate 230 are arranged in sequence along the central axis direction of the cylindrical cover 210. When the magnet assembly 222 and the voice coil assembly 221 interact, the magnet assembly 222 drives the cylindrical cover 210 to vibrate via the vibration transmitting plate 223.

Of course, in some other embodiments, the first one of the voice coil assembly 221 and the magnet assembly 222 is the magnet assembly 222, and the second one of the voice coil assembly 221 and the magnet assembly 222 is the voice coil assembly 221. Specifically, the magnet assembly 222 may be fixedly attached to the inner wall of the cylindrical cover 210, and the magnet assembly 222 is arranged to surround the voice coil assembly 221. The voice coil assembly 221 is connected to the cylindrical cover 210 through the vibration transmitting plate 223. The magnet assembly 222 and the voice coil assembly 221 interact with each other. The magnet assembly 222 may directly drive the cylindrical cover 210 to vibrate, and the cylindrical cover 210 thereby drives the housing assembly 100 to vibrate.

Providing the vibration transmitting plate 223 to elastically constrain the voice coil assembly 221 and the magnet assembly 222 for a relative movement may ensure that the magnet assembly 222 is always located within the surroundings of the voice coil assembly 221. In this way, the interaction between the magnetic field and the current between the voice coil assembly 221 and the magnet assembly 222 is maintained, thereby maintaining the vibration of the magnet assembly 222. This enables the bone conduction speaker 200 to achieve the bone conduction function for a long time.

In some embodiments, as shown in FIG. 16, the vibration transmitting plate 223 is located between the second one of the voice coil assembly 221 and the magnet assembly 222 and a corresponding sealing plate 230. The sealing plate 230 is configured to rigidly constrain a deformation amplitude of the vibration transmitting plate 223 along the central axis direction, thereby rigidly constraining a relative movement range between the voice coil assembly 221 and the magnet assembly 222.

Specifically, during the interaction between the voice coil assembly 221 and the magnet assembly 222, the second one of the voice coil assembly 221 and the magnet assembly 222 affects the vibration transmitting plate 223, causing the vibration transmitting plate 223 to undergo an elastic deformation. Therefore, providing the sealing plate 230 on the side of the vibration transmitting plate 223 opposite to the voice coil assembly 221 and the magnet assembly 222 to rigidly constrain the deformation amplitude of the vibration transmitting plate 223 may prevent the vibration transmitting plate 223 from deforming beyond an elastic limit of the vibration transmitting plate 223 during the deformation process. This prevents the vibration transmitting plate 223 from transitioning from the elastic deformation to a plastic deformation, thereby protecting the vibration transmitting plate 223.

A fixed position of the sealing plate 230 may be determined according to the relative movement range of the voice coil assembly 221 and the magnet assembly 222 and the elastic limit of the vibration transmitting plate 223. This enables the sealing plate 230 to constrain the relative movement range between the voice coil assembly 221 and the magnet assembly 222. Therefore, the sealing plate 230 and the vibration transmitting plate 223 may together constrain the relative movement range between the voice coil assembly 221 and the magnet assembly 222 within a maximum relative movement range. This protects the vibration transmitting plate 223, the voice coil assembly 221, and the magnet assembly 222, and also improves the vibration effect of the bone conduction speaker 200.

In some embodiments, as shown in FIG. 8 and FIG. 16, the vibration transmitting plate 223 includes a central fixing portion 2231, an annular fixing portion 2232 surrounding the central fixing portion 2231, and a connecting rod assembly 2233 connected between the central fixing portion 2231 and the annular fixing portion 2232. The annular fixing portion 2232 is connected to the cylindrical cover 210. The central fixing portion 2231 is connected to the second one of the voice coil assembly 221 and the magnet assembly 222.

The connecting rod assembly 2233 may undergo elastic deformation. When a current passes through the voice coil assembly 221, the connecting rod assembly 2233 may elastically constrain the second one of the voice coil assembly 221 and the magnet assembly 222. The elastic constraint may be understood as the second one of the voice coil assembly 221 and the magnet assembly 222 performing a relative movement within the relative movement range allowed by the elastic deformation of the connecting rod assembly 2233. On one hand, the connecting rod assembly 2233 may constrain the relative movement range between the voice coil assembly 221 and the magnet assembly 222 along the central axis direction. On the other hand, after the voice coil assembly 221 and the magnet assembly 222 achieve the relative movement, the connecting rod assembly 2233 may return the voice coil assembly 221 and the magnet assembly 222 to their original positions through an elastic recovery.

As the vibration transmitting plate 223 includes the connecting rod assembly 2233, the vibration transmitting plate 223 has an excellent elastic deformation capability. However, the vibration transmitting plate 223 is also in communication with an interior of the cylindrical cover 210 and may not form a sealed space with the cylindrical cover 210. The sealing plate 230 may block openings on the vibration transmitting plate 223 to form the sealed space with the cylindrical cover 210. Such an arrangement may improve the magnetic circuit performance of the bone conduction speaker 10 and enhance the sound quality.

In a natural state, the central fixing portion 2231 and the corresponding sealing plate 230 are spaced apart in the central axis direction. The natural state refers to a state when no current passes through the voice coil assembly 221, that is, when the voice coil assembly 221 and the magnet assembly 222 are relatively stationary. When the voice coil assembly 221 and the magnet assembly 222 are relatively stationary, providing a gap between the central fixing portion 2231 and the corresponding sealing plate 230 in the central axis direction enables the second one of the voice coil assembly 221 and the magnet assembly 222 to have a space for vibrating relative to the cylindrical cover 210 in the central axis direction. This enables the bone conduction to the user’s body through the cylindrical cover 210 and the housing assembly 100 in the central axis direction.

Optionally, in the natural state, the central fixing portion 2231 is closer to the second one of the voice coil assembly 221 and the magnet assembly 222 than the annular fixing portion 2232 in the central axis direction. In the natural state, the vibration transmitting plate 223 may have a certain pre-deformation, that is, the connecting rod assembly 2233 of the vibration transmitting plate 223 has some pre-deformation. This ensures that in the natural state, two vibration transmitting plates 223 may act on the magnet assembly 222 on both sides of the magnet assembly 222, ensuring that the magnet assembly 222 is at a middle position of the cylindrical cover 210. Moreover, in subsequent vibration processes, the vibration of the magnet assembly 222 may be more stable.

In embodiments of the present disclosure, the sealing plate 230 is a flat plate, a concave plate with a middle position recessed toward the magnet assembly 222 relative to an edge position, or a convex plate with a middle position protruding away from the magnet assembly 222 relative to the edge position.

In some embodiments, a distance between the central fixing portion 2231 and the corresponding sealing plate 230 is in a range of 0.005-0.8 mm.

Defining the distance between the central fixing portion 2231 and the corresponding sealing plate 230 enables the driving assembly 220 to drive the central fixing portion 2231 to vibrate within this distance, thereby driving the cylindrical cover 210 to vibrate.

Optionally, the distance between the central fixing portion 2231 and the corresponding sealing plate 230 may be a distance from a center point of the central fixing portion 2231 to a center point of the sealing plate 230. As shown in FIG. 9, the distance between the central fixing portion 2231 and the corresponding sealing plate 230 may be as shown by a distance H in the figure. For example, the distance from the center point of the central fixing portion 2231 to the center point of the sealing plate 230 is 0.2 mm, 0.5 mm, or 0.7 mm. Setting the distance between the central fixing portion 2231 and the corresponding sealing plate 230 in this way enables the sealing plate 230 to correspondingly limit the vibration of the central fixing portion 2231 and the driving assembly 220. This prevents the vibration amplitude of the driving assembly 220 from being too great, which would cause a deformation of the connecting rod assembly 2233 to exceed a tolerance range of the connecting rod assembly 2233 and cause damage.

As shown in FIG. 8 and FIG. 9, the magnet assembly 222 may further include a magnet 2221 and two magnetic conducting plates 2222. The two magnetic conducting plates 2222 are respectively disposed on two opposite side surfaces of the magnet 2221 along the central axis direction. The magnetic conducting plate 2222 has a protruding portion 2201 protruding toward the central fixing portion 2231. The protruding portion 2201 is fixedly connected to the central fixing portion 2231.

The magnetic conducting plate 2222 is configured to constrain a direction of a magnetic field of the magnet 2221 on the two opposite end surfaces of the magnet 2221 along the central axis direction, thereby enhancing the interaction effect between the magnet 2221 and a voice coil 2211.

The two protruding portions 2201 of the two magnetic conducting plates 2222 protrude toward the central fixing portions 2231 of the two vibration transmitting plates 223 opposite to the two magnetic conducting plates 2222, respectively. That is, the directions of the two protruding portions 2201 are opposite. By providing the protruding portion 2201 to be fixedly connected to the central fixing portion 2231, the two magnetic conducting plates 2222 and the two vibration transmitting plates 223 may achieve a relatively stable fixed connection. This also enables a connection portion between the magnetic conducting plate 2222 and the vibration transmitting plate 223 to not occupy too much space in the connecting rod assembly 2233. This enables the connecting rod assembly 2233 to have a sufficient region for elastic deformation, thereby providing a sufficient deformation space and making the vibration transmitting plate 223 more elastic.

In some embodiments, as shown in FIG. 8 and FIG. 9, the voice coil assembly 221 further includes two sets of voice coils 2211 spaced apart along the central axis direction. The cylindrical cover 210 surrounds the two sets of voice coils 2211. Projections of the two magnetic conducting plates 2222 along a radial direction of the bone conduction speaker 200 at least partially overlap with the two sets of voice coils 2211, respectively. The electrification directions of the two sets of voice coils 2211 are opposite to each other.

The radial direction of the bone conduction speaker 200 is as shown by an arrow Y in FIG. 9. By providing the projections of the two magnetic conducting plates 2222 along the radial direction of the bone conduction speaker 200 to at least partially overlap with the two sets of voice coils 2211, respectively, the interaction between the two magnetic conducting plates 2222 and the two voice coils 2211, and the interaction between the magnet 2221 and the two voice coils 2211 are strengthened, making the magnet assembly 222 more sensitive. Moreover, the electrification directions of the two voice coils 2211 are opposite to each other to ensure that the two voice coils 2211 have the same force direction under the interaction with the same magnet 2221, thereby enabling the magnet 2221 to move in one direction under the action of the two voice coils 2211 and the magnetic field. Furthermore, by changing the current directions of the two voice coils 2211, the magnet 2221 may be caused to vibrate in the central axis direction.

In some embodiments, the accommodation space 211 is filled with a magnetic fluid. The magnetic fluid occupies at least a portion of the accommodation space 211.

The magnetic fluid is also called a magnetic liquid, a ferrofluid, or a ferrite. The magnetic fluid has the fluidity of a liquid and the magnetism of a solid magnetic material. Compared with the air, the magnetic fluid has a better magnetic permeability, which increases the magnetic field effect of the magnet assembly 222 and makes the vibration of the magnet assembly 222 more sensitive. In addition, the presence of the magnetic fluid may also reduce the resistance to the relative movement between the voice coil assembly 221 and the magnet assembly 222, thereby improving the vibration effect, effectively improving the sound quality, thereby improving the bone conduction effect of the bone conduction speaker 200, and improving the sound quality effect of the speaker assembly 10.

Optionally, the magnetic fluid may fill the accommodation space 211. In this way, a fluid resistance is reduced, and the bone conduction effect of the bone conduction speaker 200 is improved.

In some embodiments, when the bone conduction speaker 200 vibrates along an axis of the bone conduction speaker 200, the bone conduction speaker 200 drives the housing assembly 100 to vibrate. The air conduction speaker 300 and the housing assembly 100 become vibration loads. In related technologies, the air conduction speaker 300 is usually disposed beside the axis of the bone conduction speaker 300 (e.g., the air conduction speaker 300 is often disposed on the radial direction of the bone conduction speaker 200 perpendicular to the axis of the bone conduction speaker 200). In this case, a mass of the air conduction speaker 300 causes bias to the vibration of the bone conduction speaker 200, so that the speaker assembly 10 generates two torques in different directions, the vibration of the bone conduction speaker 200 along the axis weakens, thereby reducing the volume of a bone conduction component of the earphone 1.

To solve the above problem, the following embodiments provide exemplary descriptions regarding positions, structures, and other contents of the speaker assembly 10 with respect to the bone conduction speaker 200 and the air conduction speaker 300.

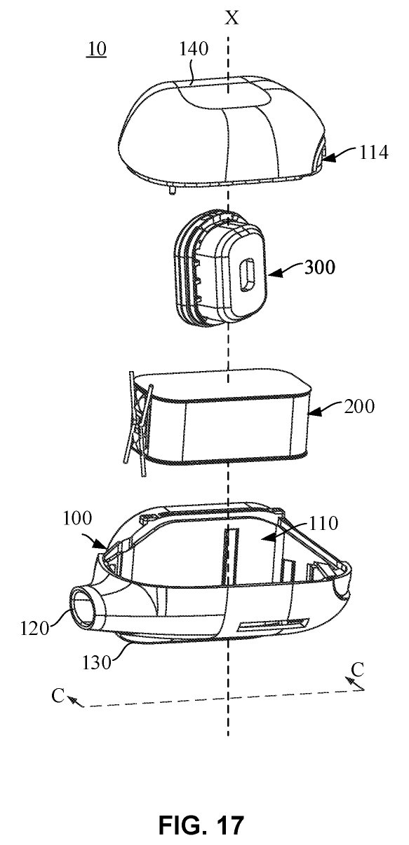

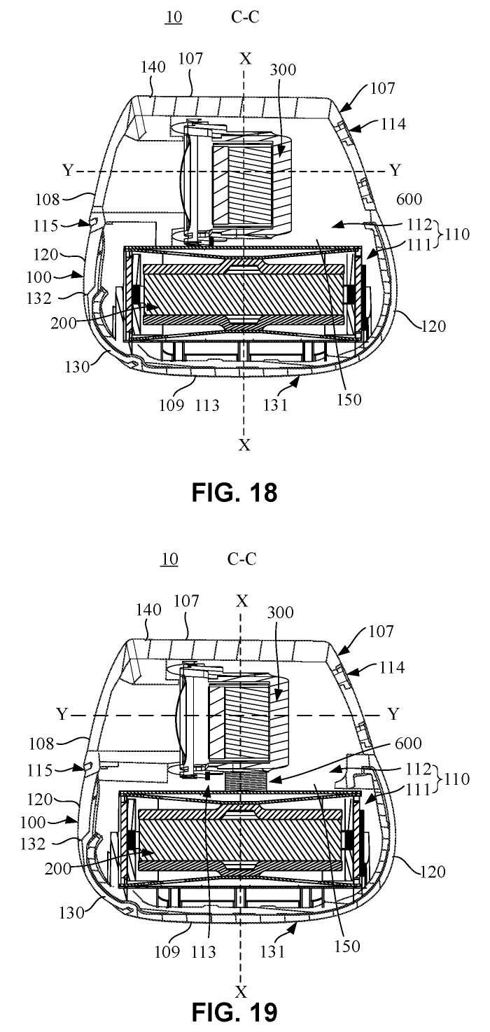

As shown in FIG. 17 and FIG. 18, as described above, a bone conduction core module 200 and an air conduction core module 300 are disposed in the housing assembly 100. The bone conduction core module 200 may also be referred to as the bone conduction speaker 200, and is configured to conduct sound to the user through a bone conduction vibration manner. The air conduction core module 300 may be referred to as the air conduction speaker 300, and is configured to conduct sound into the ear canal of the user through an air vibration principle.

Optionally, the housing assembly 100 is disposed with the accommodation space 110. The bone conduction core module 200 may be disposed in the accommodation space 110 and vibrate in a first vibration direction. The air conduction core module 300 is disposed in the accommodation space 110 and is arranged opposite to the bone conduction core module 200 along the first vibration direction. Specifically, the air conduction core module 300 is arranged opposite to the bone conduction core module 200, which means that, on a reference horizontal plane perpendicular to the first vibration direction, a projection of the air conduction core module 300 and a projection of the bone conduction core module 200 have an overlapping region.

The first vibration direction of the bone conduction core module 200 may be consistent with a central axis direction of the bone conduction core module 200, as shown by an arrow X in FIG. 18.

Disposing the air conduction core module 300 in the first vibration direction of the bone conduction core module 200 makes the mass of the air conduction core module 300 more concentrated on the axis of the bone conduction core module 200. When the bone conduction core module 200 vibrates along the first vibration direction, a biasing effect of the air conduction core module 300 on the vibration of the bone conduction core module 200 is weakened. This enables the bone conduction core module 200 to better drive the housing assembly 100 to vibrate in the first vibration direction. The sound quality generated by the vibration of the bone conduction core module 200 is purer and conforms to acoustic design principles. In this way, the influence of the mass of the air conduction core module 300 on the vibration effect of the bone conduction core module 200 is reduced, which enables the bone conduction core module 200 to have a better bone conduction effect, improves the sound quality effect of the bone conduction component of the earphone 1.

In some embodiments, the air conduction core module 300 vibrates in a second vibration direction. An angle between the first vibration direction and the second vibration direction is in a range of 70°-100°, or in a range of 80°-90°.

Setting the first vibration direction and the second vibration direction to be different from each other and intersect with each other may reduce mutual interference between the air conduction core module 300 and the bone conduction core module 200. This setting enables the air conduction core module 300 to have a better sound output effect, and enables the bone conduction core module 200 to have a good bone conduction effect.

An angle formed by the first vibration direction and the second vibration direction is 75°, 85°, or 95°. For example, optionally, the first vibration direction and the second vibration direction are perpendicular to each other. That is, the angle formed by the first vibration direction and the second vibration direction is 90°. The second vibration direction may be the axial direction of the air conduction core module 300. The second vibration direction may refer to the direction indicated by an arrow Y in FIG. 18.

In this way, the mutual influence between the air conduction core module 300 and the bone conduction core module 200 is greatly reduced. The respective vibration of the air conduction core module 300 and the bone conduction core module 200 is less likely to be affected by the vibration of the other, thereby improving the sound quality of the earphone 1.

In some embodiments, as shown in FIG. 17 to FIG. 18, the housing assembly 100 is provided with a first side surface 107, a second side surface 108, and a vibration transmission surface 109 (i.e., the face-contacting side mentioned in the previous content). The first side surface 107, the second side surface 108, and the vibration transmission surface 109 are not coplanar with each other. The first side surface 107 and the second side surface 108 are spaced apart in a direction perpendicular to the first vibration direction. The housing assembly 100 may be provided with a sound output hole 114 penetrating the first side surface 107 and communicating with the accommodation space 110, and a pressure relief hole 115 penetrating the second side surface 108 and communicating with the accommodation space 110.

The sound output hole 114 and the pressure relief hole 115 are respectively configured to conduct at least a portion of the sound waves generated by the air conduction core module 300 to the external environment. The difference is that the sound output hole 114 is typically arranged toward the face or close to the user’s ear, thereby conducting a portion of the sound waves generated by the air conduction core module 300 to the user’s ear. The pressure relief hole 115 is configured to release the air in the accommodation space 110 that creates damping for vibration of the air conduction speaker 300, thereby achieving an air pressure balance in the accommodation space 110 to reduce the impact on the vibration effect of the air conduction core module 300.

By separately arranging the sound output hole 114 and the pressure relief hole 115 on the oppositely arranged first side surface 107 and second side surface 108, a distance between the sound output hole 114 and the pressure relief hole 115 can be relatively increased. This arrangement thereby reduces the mutual influence, especially the destructive interference, between a portion of sound waves released from the pressure relief hole 115 and sound waves conducted from the sound output hole 114, thereby improving the sound quality of sound conducted from the sound output hole 114. In other embodiments, positions of the sound output hole 114 and the pressure relief hole 115 on the housing assembly 100 are swapped, depending on a specific position of the human ear.

Optionally, the vibration transmission surface 109 may be perpendicular to the first vibration direction. The bone conduction core module 200 transmits vibration outward through the vibration transmission surface 109. Such a setting enables the pressure relief hole 115, the sound output hole 114, and the vibration transmission surface 109 to all be non-coplanar, thereby making it less likely for the sound waves conducted from the sound output hole 114, the sound waves released from the pressure relief hole 115, and the vibration on the vibration transmission surface 109 to interfere with each other, enabling the sound output hole 114 and the pressure relief hole 115 to improve the sound quality of the speaker assembly 10.

In some embodiments, as shown in FIG. 18, the air conduction core module 300 is stacked on the bone conduction core module 200 along the first vibration direction. In other words, the air conduction core module 300 and the bone conduction core module 200 are stacked along the first vibration direction. Optionally, the air conduction core module 300 is fixedly connected to the bone conduction core module 200.

By fixing the air conduction core module 300 to the bone conduction core module 200 along the first vibration direction, the bone conduction core module 200 may conveniently drive the air conduction core module 300 to vibrate, thereby reducing an impact of a counterweight of the air conduction core module 300 on the vibration of the bone conduction core module 200, ensuring the bone conduction effect of the speaker assembly 10.

In some embodiments, as shown in FIG. 19, an elastic buffer member 600 is disposed between the air conduction core module 300 and the bone conduction core module 200. The elastic buffer member 600 may be an element such as an elastic colloid (e.g., silicone, rubber, etc.), a spring, an airbag, or a magnetic fluid. In this way, on one hand, a vibration influence and a limitation of the air conduction core module 300 on the bone conduction core module 200 are reduced, and the bone conduction core module 200 is enabled to vibrate more freely with a better vibration effect. On the other hand, the elastic buffer member 600 may protect the air conduction core module 300.

In some embodiments, at least one of the air conduction core module 300 and the bone conduction core module 200 is relatively fixed to the housing assembly 100. Optionally, the air conduction core module 300 and the bone conduction core module 200 are respectively fixedly connected to the housing assembly 100. In this way, operational stabilities of the bone conduction core module 200 and the air conduction core module 300 are improved.

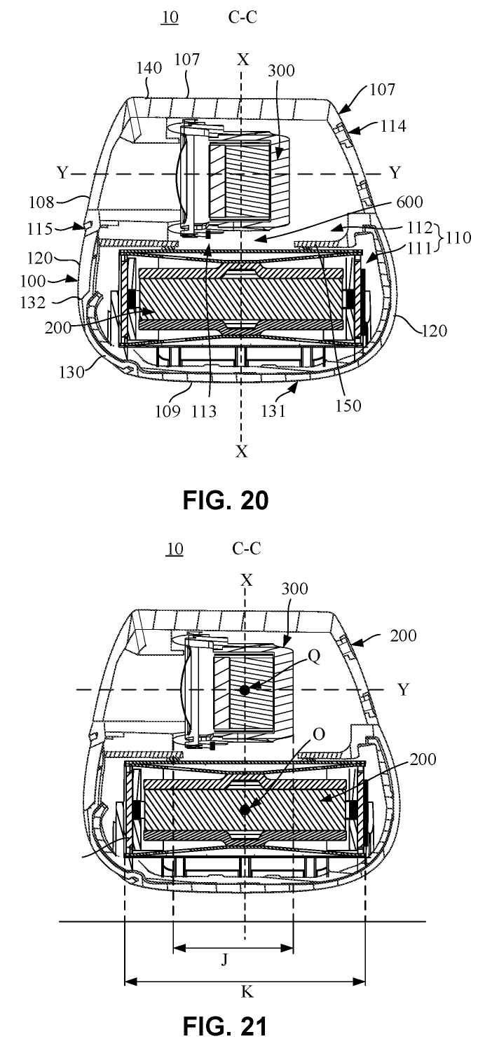

In some embodiments, as shown in FIG. 20, the air conduction core module 300 and the bone conduction core module 200 are spaced apart in the first vibration direction. In this way, on one hand, the impact of the weight of the air conduction core module 300 on the bias generated by the vibration of the bone conduction core module 200 is reduced. On the other hand, spacing the air conduction core module 300 and the bone conduction core module 200 apart also reduces the mutual influence between the vibrations of the air conduction core module 300 and the bone conduction core module 200, thereby reducing the possibility of vibration interference. Optionally, the air conduction core module 300 may be fixedly connected to the housing assembly 100. When the bone conduction core module 200 drives the housing assembly 100 to vibrate, the housing assembly 100 further drives the air conduction core module 300 to vibrate.

Optionally, the housing assembly 100 may be provided with a partition wall 150. The accommodation space 110 may include the first accommodation cavity 111 and the second accommodation cavity 112 separated by the partition wall 150. The bone conduction core module 200 is disposed in the first accommodation cavity 111. The air conduction core module 300 is disposed in the second accommodation cavity 112.

Optionally, as shown in FIG. 19, the housing assembly 100 includes the first housing 120, the second housing 130, and the third housing 140. The second housing 130 is joined to the first housing 120, and the second housing 130 and the first housing 120 cooperate with each other to form the first accommodation cavity 111. The third housing 140 is respectively joined to the first housing 120 and the second housing 130, and the third housing 140 cooperates with the first housing 120 to form the second accommodation cavity 112. Through the above arrangement, the speaker assembly 10 may be conveniently installed and disassembled.

As the bone conduction core module 200 requires an environment with a strong impermeability to ensure the bone conduction effect, disposing the bone conduction core module 200 and the air conduction core module 300 in different cavities may improve the bone conduction effect of the bone conduction core module 200. Optionally, the first accommodation cavity 111 may be sealed to provide the first accommodation cavity 111 with better airtightness.

Optionally, the shape and size of the first accommodation cavity 111 match the shape and size of the bone conduction core module 200. This arrangement may reduce the size of the speaker assembly 10, and also facilitate the bone conduction core module 200 to drive the housing assembly 100 to vibrate, thereby transmitting the bone conduction to the user’s body.

In some embodiments, as shown in FIG. 20, the air conduction core module 300 generates the vibration in the second vibration direction. The housing assembly 100 is provided with the sound output hole 114 and the pressure relief hole 115 communicating with the second accommodation cavity 112. The sound output hole 114 is configured to conduct a portion of the sound waves generated by the air conduction speaker 300 to the outside of the speaker assembly 10. The pressure relief hole 115 is configured to communicate the second accommodation cavity 112 with the external environment to ensure an air pressure balance inside the second accommodation cavity 112, thereby reducing an air pressure accumulation that affects the sound effect produced by the air conduction speaker 300.

The sound output hole 114 and the pressure relief hole 115 are respectively disposed on two side walls of the housing assembly 100 that are spaced apart from each other in the second vibration direction. Such an arrangement may reduce the mutual interference between the sound waves spread from the sound output hole 114 and the pressure relief hole 115, thereby improving the sound quality of the speaker assembly 10.

In some embodiments, as shown in FIG. 20, the bone conduction core module 200 has the first central axis X extending along the first vibration direction. The air conduction core module 300 may generate the vibration in the second vibration direction, and may have the second central axis Y extending along the second vibration direction. An angle between the first central axis X and the second central axis Y may be in a range of 70°-100°.

For example, the angle between the first central axis X and the second central axis Y is 80°, 85°, 90°, etc. Optionally, the angle between the first central axis X and the second central axis Y is 90°. In this way, the mutual influence between the vibration of the bone conduction core module 200 and the vibration of the air conduction core module 300 may be reduced, thereby ensuring the sound quality of the speaker assembly 10.

In some embodiments, as shown in FIG. 20, the second housing 130 has a contact region 131 that contacts the user’s face in a wearing state. A joint seam 132 between the first housing 120 and the second housing 130 is located outside the contact region 131. Arranging the joint seam 132 between the first housing 120 and the second housing 130 outside the contact region 131 rather than within the contact region 131 may prevent the joint seam 132 from pinching the user’s skin when the earphone 1 is in use.

In some embodiments, the air conduction core module 300 and the bone conduction core module 200 are arranged along the first vibration direction. Optionally, projections of the bone conduction core module 200 and the air conduction core module 300 on a reference plane perpendicular to the first vibration direction may have an overlapping region.

As shown in FIG. 21, the projection of the bone conduction core module 200 on the reference plane perpendicular to the first vibration direction may be as shown by K in FIG. 21. The projection of the air conduction core module 300 on the reference plane perpendicular to the first vibration direction may be as shown by J in FIG. 21. J and K have an overlapping portion. Through the above arrangement, when the bone conduction core module 200 vibrates in the first vibration direction, the bone conduction core module 200 may conveniently drive the air conduction core module 300 to vibrate together.

The structure of the bone conduction core module 200 is relatively compact, resulting in a relatively concentrated and uniform mass. The vibration of the air conduction core module 300 mainly comes from the diaphragm 310. The diaphragm 310 occupies a great space but has a light weight. The mass of the air conduction core module 300 is mainly concentrated on a side of the air conduction core module 300 deviating from the diaphragm 310, i.e., close to a magnetic circuit assembly 322. Volumes of the bone conduction core module 200 and the air conduction core module 300 are specifically designed according to acoustic requirements. Therefore, the overlapping region between the bone conduction core module 200 and the air conduction core module 300 in a direction perpendicular to the first vibration direction is designed as follows.

Optionally, a ratio of the overlapping region to the projection area of the air conduction core module 300 on the reference plane may be greater than 20%, or greater than 40%, or greater than 60%. For example, a ratio of the overlapping region to the projection area of the air conduction core module 300 on the reference plane may be 25%, 45%, 50%, or 100%.

Optionally, a ratio of the overlapping region to the projection area of the bone conduction core module 200 on the reference plane is greater than 20%, greater than 40%, or greater than 60%. For example, a ratio of the overlapping region to the projection area of the bone conduction core module 200 on the reference plane may be 25%, 45%, 50%, or 100%.

Arranging the air conduction core module 300 and the bone conduction core module 200 in such a manner may effectively cause a majority of the weight of the air conduction core module 300 to fall on the bone conduction core module 200 in the first vibration direction. Accordingly, the influence of the air conduction core module 300 on the vibration of the bone conduction core module 200 may be reduced, thereby improving the vibration effect of the bone conduction core module 200 and enhancing the bone conduction sound quality effect of the bone conduction core module 200.

In some embodiments, as shown in FIG. 21, a distance between a projection of a mass center of the bone conduction core module 200 on the reference plane perpendicular to the first vibration direction and a projection of a mass center of the air conduction core module 300 on the reference plane is less than 0.5 mm. The mass center of the bone conduction core module 200 may be as shown by point O in FIG. 20, and the mass center of the air conduction core module 300 may be as shown by point Q in FIG. 20.

In a direction perpendicular to the first vibration direction, a smaller distance between the mass center of the bone conduction core module 200 and the mass center of the air conduction core module 300 results in a smaller influence of a weight bias of the air conduction core module 300 on the vibration of the bone conduction core module 200. Then, the vibration effect is better, and the sound quality effect is also better.

Optionally, the distance between the mass center of the bone conduction core module 200 and the mass center of the air conduction core module 300 may be in a range of 0-0.4 mm, or in a range of 0-0.2 mm. For example, as shown in FIG. 20, the distance between the mass center of the bone conduction core module 200 and the mass center of the air conduction core module 300 is 0 mm. That is, the mass center of the air conduction core module 300 and the mass center of the bone conduction core module 200 are both located in the first vibration direction. In other words, on the reference plane perpendicular to the first vibration direction, the mass center of the air conduction core module 300 and the mass center of the bone conduction core module 200 completely overlap. Therefore, setting the distance between the bone conduction core module 200 and the air conduction core module 300 in such a manner may reduce different moments generated by the vibration of the bone conduction core module 200 and the air conduction core module 300. Accordingly, the bone conduction core module 200 may have a better bone conduction effect, and the speaker assembly 10 may have a better sound quality effect.

Certainly, in other embodiments, on the reference plane perpendicular to the first vibration direction, the distance between the projection of the mass center of the air conduction core module 300 and the projection of the mass center of the bone conduction core module 200 is 0.1 mm, 0.25 mm, 0.3 mm, etc. The present embodiment does not list all possibilities here.

Alternatively, the bone conduction core module 200 may have the first central axis X, and the first vibration direction is the direction of the first central axis X. The distance between the mass center of the air conduction core module 300 and the first central axis X is less than or equal to 0.5 mm. Similarly, a small distance between the mass center of the air conduction core module 300 and the first central axis X results in a smaller influence of the air conduction core module 300 on the vibration of the bone conduction core module 200.

For example, optionally, as shown in FIG. 20, the distance between the mass center of the air conduction core module 300 and the first central axis X is equal to 0 mm. Setting the distance between the bone conduction core module 200 and the air conduction core module 300 in such a manner also facilitates the bone conduction core module 200 driving the air conduction core module 300 to vibrate together along the direction of the first central axis X. Accordingly, the bone conduction speaker 200 may have a better bone conduction effect, and the speaker assembly 10 may have a better sound quality effect.

Similarly, in other embodiments, the distance between the mass center of the air conduction core module 300 and the first central axis X is 0.1 mm, 0.2 mm, 0.3 mm, etc. The present embodiment does not list all possibilities here.

In some embodiments, as shown in FIG. 21, the bone conduction core module 200 is configured as a sealed structure, and the interior of the bone conduction core module 200 and the accommodation space 110 are separated from each other.

Optionally, as shown in FIG. 8 and FIG. 9, the bone conduction core module 200 includes the cylindrical cover 210, the driving assembly 220, and the two sealing plates 230. The cylindrical cover 210 is fixedly connected to the housing assembly 100. The driving assembly 220 is disposed in the cylindrical cover 210. The driving assembly 220 is configured to drive the cylindrical cover 210 to vibrate, thereby driving the housing assembly 100 to vibrate. The two sealing plates 230 are respectively disposed at two ends of the cylindrical cover 210 and seal the cylindrical cover 210 to form the sealed structure.

Vibration of the driving assembly 220 within the sealed cylindrical cover 210 may make the driving assembly 220 less susceptible to air resistance and other influencing factors during the vibration process. Accordingly, the bone conduction core module 200 may be ensured to have a good bone conduction effect. Moreover, during a drop impact process of the earphone 1, the sealed cylindrical cover 210 may also prevent the driving assembly 220 from falling out of the cylindrical cover 210 and causing damage to internal structures. Accordingly, the structural stability of the bone conduction core module 200 may be improved.

Optionally, the bone conduction core module 200 may include the vibration transmitting plate 223. The driving assembly 220 includes the voice coil assembly 221 and the magnet assembly 222. The voice coil assembly 221 is sleeved on the magnet assembly 222. The vibration transmitting plate 223 fixedly connects the cylindrical cover 210 and the magnet assembly 222. The voice coil assembly 221 is fixedly connected to the cylindrical cover 210. The voice coil assembly 221 is configured to receive an electrical signal and interact with the magnet assembly 222 to cause the magnet assembly 222 to vibrate. The magnet assembly 222 is configured to drive the cylindrical cover 210 to vibrate after interacting with the voice coil assembly 221. The vibration transmitting plate 223 is configured to limit the position of the magnet assembly 222. Specifically, covering the cylindrical cover 210 with the two sealing plates 230 to form a sealed structure may better constrain the direction of the magnetic field, making the vibration of the magnet assembly 222 more sensitive. The sealed structure may also prevent the vibration transmitting plate 223 and the magnet assembly 222 from falling out of the cylindrical cover 210.

In some embodiments, the magnetic fluid occupies at least a portion of the internal space of the cylindrical cover 210. The magnetic fluid, also known as the ferrofluid, is a fluid that possesses both a liquid fluidity and the magnetic properties of the solid magnetic materials. Compared to air, the magnetic fluid has a better magnetic permeability, which enhances the magnetic field effect of the magnet assembly 222 and makes the vibration of the magnet assembly 222 more sensitive. Accordingly, the bone conduction effect of the bone conduction core module 200 may be improved, and the sound quality effect of the speaker assembly 10 may be enhanced.

Optionally, the magnetic fluid may not fill the internal space of the cylindrical cover 210. In this way, the fluid resistance is reduced, and the bone conduction effect of the bone conduction core module 200 is improved.

Based on the above embodiments, the earphone 1 may include the speaker assembly 10 according to each of the above embodiments.

In summary, the present disclosure disposes the pressure relief hole 15 and the sound output hole 114 on two opposite side surfaces of the housing assembly 100 of the speaker assembly 10. Accordingly, the distance between the sound output hole 114 and the pressure relief hole 115 increases, thereby reducing the mutual influence between the sound waves conducted by the sound output hole 114 and the sound waves conducted by the pressure relief hole 115, and reducing the interference cancellation between the sound output hole 114 and the pressure relief hole 115 in the near-field (this weakens the sound waves transmitted from the sound output hole 114). As a result, the acoustic cancellation phenomenon between sound waves conducted by the sound output hole 114 and the pressure relief hole 115 may be weakened, the low-frequency sound quality can be improved, and the sound quality effect can be improved.

The above descriptions are merely partial embodiments of the present disclosure and do not limit the scope of protection of the present disclosure. Any equivalent device or equivalent process transformation made based on the content of the present disclosure and the drawings of the present disclosure, or any direct or indirect application in other related technical fields, shall similarly be included within the scope of patent protection of the present disclosure.

What is claimed is:

1. A speaker assembly, comprising:
a housing assembly disposed with an accommodation space;
an air conduction speaker disposed in the accommodation space; and
a bone conduction speaker disposed in the accommodation space, wherein
the housing assembly is further provided with a sound output hole and a pressure relief hole that are in communication with the accommodation space,
the sound output hole and the pressure relief hole are respectively configured to conduct a portion of sound waves generated by the air conduction speaker to an external environment, and
the pressure relief hole and the sound output hole are respectively located on two opposite side surfaces of the housing assembly.

2. The speaker assembly of claim 1, wherein
the speaker assembly is provided with a pressure relief channel communicating with the pressure relief hole,
the sound output hole communicates with the accommodation space, and
the pressure relief channel is configured to guide a portion of the sound waves generated by the air conduction speaker in the accommodation space to the pressure relief hole.

3. The speaker assembly of claim 2, wherein the pressure relief channel and the accommodation space are spaced apart from each other, and the pressure relief channel communicates with the accommodation space.

4. The speaker assembly of claim 3, wherein
the accommodation space includes a first accommodation cavity and a second accommodation cavity separated from each other,
the bone conduction speaker is disposed in the first accommodation cavity,
the air conduction speaker is disposed in the second accommodation cavity,
the sound output hole communicates with the second accommodation cavity,
the pressure relief channel is spaced apart from the first accommodation cavity, and
the pressure relief channel communicates with the second accommodation cavity and the pressure relief hole.

5. The speaker assembly of claim 4, wherein
in a vertical direction perpendicular to an arrangement direction of the first accommodation cavity and the second accommodation cavity, the pressure relief channel and the first accommodation cavity are spaced apart.

6. The speaker assembly of claim 5, wherein
a length component of an extension length of the pressure relief channel along the arrangement direction is greater than a length component of the extension length along the vertical direction.

7. The speaker assembly of claim 4, wherein
the housing assembly is provided with a first partition wall between the first accommodation cavity and the second accommodation cavity, and a second partition wall between the pressure relief channel and the first accommodation cavity;
the first partition wall separates the second accommodation cavity and the first accommodation cavity; and
the second partition wall separates the pressure relief channel and the first accommodation cavity.

8. The speaker assembly of claim 7, wherein
the first partition wall further extends between the second accommodation cavity and the pressure relief channel,
the first partition wall is provided with a sound guiding hole, and
the sound guiding hole communicates with the second accommodation cavity and the pressure relief channel.

9. The speaker assembly of claim 4, wherein
the first accommodation cavity and the second accommodation cavity are separated from each other, and
an area of a communication portion between the first accommodation cavity and the external environment is less than an area of a communication portion between the second accommodation cavity and the external environment, and an area of a communication portion between the pressure relief channel and the external environment.

10. The speaker assembly of claim 4, wherein
the housing assembly is provided with a first communication hole between the first accommodation cavity and the second accommodation cavity, wherein the first communication hole communicates with the first accommodation cavity and the second accommodation cavity, and
the bone conduction speaker blocks the first communication hole, so that the first accommodation cavity and the second accommodation cavity are separated from each other.

11. The speaker assembly of claim 10, wherein
the housing assembly is provided with a second communication hole between the first accommodation cavity and the pressure relief channel, wherein the second communication hole communicates with the first accommodation cavity and the pressure relief channel, and
the bone conduction speaker blocks the second communication hole, so that the first accommodation cavity and the pressure relief channel are separated from each other.

12. The speaker assembly of claim 4, wherein
the speaker assembly includes a channel tube forming the pressure relief channel, wherein the channel tube is fixedly disposed in the housing assembly and located in the second accommodation cavity, one end of the channel tube communicates with the second accommodation cavity, and the other end of the channel tube communicates with the pressure relief hole.

13. The speaker assembly of claim 2, wherein
a portion of the accommodation space forms the pressure relief channel.

14. The speaker assembly of claim 13, wherein
the bone conduction speaker is configured as a sealed structure, an interior of the bone conduction speaker is separated from the accommodation space, and
the pressure relief channel is defined by a space enclosed between the bone conduction speaker and an inner wall of the accommodation space.

15. The speaker assembly of claim 14, wherein
the accommodation space includes a first accommodation cavity and a second accommodation cavity spaced apart from each other,
the bone conduction speaker is disposed in the first accommodation cavity,
the pressure relief channel is defined by a space enclosed between the bone conduction speaker and an inner wall of the first accommodation cavity,
the air conduction speaker is disposed in the second accommodation cavity,
the housing assembly is provided with a sound guiding hole between the first accommodation cavity and the second accommodation cavity, and
the sound guiding hole communicates with the first accommodation cavity and the second accommodation cavity.

16. The speaker assembly of claim 14, wherein the bone conduction speaker includes a cylindrical cover, a driving assembly, and two sealing plates, wherein
the cylindrical cover is fixedly connected to the housing assembly,
the driving assembly is disposed in the cylindrical cover,
the driving assembly is configured to drive the cylindrical cover to vibrate, thereby driving the housing assembly to vibrate, and
the two sealing plates are respectively disposed at two ends of the cylindrical cover and block the cylindrical cover to form the sealed structure.

17. The speaker assembly of claim 16, wherein
the bone conduction speaker includes a vibration transmitting plate,
the driving assembly includes a voice coil assembly and a magnet assembly,
the voice coil assembly is sleeved on the magnet assembly,
the vibration transmitting plate fixedly connects the cylindrical cover to one of the voice coil assembly and the magnet assembly, and
the other one of the voice coil assembly and the magnet assembly is fixedly connected to the cylindrical cover.

18. The speaker assembly of claim 1, wherein
the bone conduction speaker has a first central axis and is capable of generating vibration along a direction of the first central axis,
the air conduction speaker has a second central axis and is capable of generating vibration along a direction of the second central axis;
the housing assembly includes a first housing, a second housing, and a third housing,
the first housing, the second housing, and the third housing together enclose to form the accommodation space,
the second housing is connected to the first housing along the direction of the first central axis,
the third housing is connected to the second housing along the direction of the second central axis,
the sound output hole is provided in the third housing, and
the pressure relief hole is provided in a portion of the first housing opposite the third housing.

19. The speaker assembly of claim 18, wherein the first housing is provided with a pressure relief channel, one end of the pressure relief channel communicates with the accommodation space, and the other end of the pressure relief channel forms the pressure relief hole.

20. An earphone, comprising a wearing assembly and a speaker assembly connected to the wearing assembly, wherein
the speaker assembly comprises:
a housing assembly disposed with an accommodation space;
an air conduction speaker disposed in the accommodation space; and
a bone conduction speaker disposed in the accommodation space, wherein
the housing assembly is further provided with a sound output hole and a pressure relief hole that are in communication with the accommodation space,
the sound output hole and the pressure relief hole are respectively configured to conduct a portion of sound waves generated by the air conduction speaker to an external environment, and
the pressure relief hole and the sound output hole are respectively located on two opposite side surfaces of the housing assembly.
.
